(19) United States
(12) Patent Application Publication
(10) Pub. No.: US 2024/0330735 A1
(43) Pub. Date: Oct. 3, 2024

(54) CLOUD-BASED QUANTUM COMPILATION SERVICE FOR QUANTUM CIRCUIT MAPPING USING SAT SOLVING TECHNIQUES

(71) Applicant: Amazon Technologies, Inc., Seattle, WA (US)

(72) Inventors: Yunong Shi, Old Greenwich, CT (US); Marijn J. Heule, Pittsburgh, PA (US); Michael William Whalen, Edina, MN (US); Bruno Dutertre, Mountain View, CA (US); Eric M Kessler, New Rochelle, NY (US); Benjamin Kiesl-Reiter, Munich (DE); Robert Jones, Beaverton, OR (US); David Nunnerley, Bainbridge Island, WA (US)

(73) Assignee: Amazon Technologies, Inc., Seattle, WA (US)

(21) Appl. No.: 18/193,358

(22) Filed: Mar. 30, 2023

(51) Int. Cl. G06N 10/60; G06N 10/20; G06N 10/40

(52) U.S. Cl. CPC G06N 10/60; G06N 10/20; G06N 10/40

(57) ABSTRACT

Techniques for encoding quantum circuit mapping problems as SAT solver optimization problems are disclosed. Quantum circuit mapping often requires the use of SWAP gates in order to configure logical quantum computations to be executed using fixed quantum hardware device layouts. A quantum compilation service takes a logical quantum circuit, a physical qubit connectivity graph, and a requested number of SWAP gates to solve the mapping using and encodes the information into a Conjunctive Normal Form (CNF) equation using a layout-transition-based encoding scheme. The CNF equation is then provided to a SAT solver which attempts to determine an assignment for the mapping using the set number of SWAP gates requested. Multiple CNF equations corresponding to different requested numbers of SWAP gates may be solved for in parallel using multiple SAT solving instances.

### BACKGROUND

Quantum computing utilizes the laws of quantum physics to process information. Quantum physics is a theory that describes the behavior of reality at the fundamental level. It is currently the only physical theory that is capable of consistently predicting the behavior of microscopic quantum objects like photons, molecules, atoms, and electrons.

A quantum computer is a device that utilizes quantum physics to allow one to write, store, process and read out information encoded in quantum states, e.g., the states of quantum objects. A quantum object is a physical object that behaves according to the laws of quantum physics. The state of a physical object is a description of the object at a given time.

In quantum physics, the state of a two-level quantum system, or simply, a qubit, is a list of two complex numbers whose squares sum up to one. Each of the two numbers is called an amplitude, or quasi-probability, and their squared absolute values are probabilities that a measurement of the qubit results in zero or one. A fundamental and counterintuitive difference between a probabilistic bit (e.g., a classical zero or one bit) and the qubit is that a probabilistic bit represents a lack of information about a two-level classical system, while a qubit contains maximal information about a two-level quantum system.

Quantum computers are based on such quantum bits (qubits), which may experience the phenomena of “superposition” and “entanglement.” Superposition allows a quantum system to be in multiple states at the same time. For example, whereas a classical computer is based on bits that are either zero or one, a qubit may be both zero and one at the same time, with different probabilities assigned to zero and one. Entanglement is a strong correlation between quantum systems, such that the quantum systems are inextricably linked even if separated by great distances.

A quantum algorithm comprises a reversible transformation acting on qubits in a desired and controlled way, followed by a measurement on one or multiple qubits. For example, if a system has two qubits, a transformation may modify four numbers; with three qubits this becomes eight numbers, and so on. As such, a quantum algorithm acts on a list of numbers exponentially large as dictated by the number of qubits. To implement a transform, the transform may be decomposed into small operations acting on a single qubit, or a pair of qubits, as an example. Such small operations may be called quantum gates and a specific arrangement of the quantum gates implements a quantum circuit.

There are different types of qubits that may be used in quantum computers, each having different advantages and disadvantages. For example, some quantum computers may include qubits built from superconductors, trapped ions, semiconductors, photonics, etc. Each may experience different levels of interference, errors and decoherence. Also, some may be more useful for generating particular types of quantum circuits or quantum algorithms, while others may be more useful for generating other types of quantum circuits or quantum algorithms. Also, costs, run-times, error rates, availability, etc. may vary across quantum computing technologies.

### BRIEF DESCRIPTION OF THE DRAWINGS

FIG. 1A illustrates a service provider network that enables customers to compile and execute quantum circuits using multiple quantum computing technologies, according to some embodiments.

FIG. 1B illustrates a compilation service of the service provider network that enables customers to compile and generate mappings of logical quantum circuits to quantum hardware devices, according to some embodiments.

FIG. 2 illustrates an example of a web-based implementation of a user interface of the compilation service, according to some embodiments.

FIG. 3A illustrates an example of a physical qubit connectivity graph for a given quantum hardware device and the generation of corresponding physical qubit and edge lists, according to some embodiments.

FIG. 3B illustrates an example of a logical quantum circuit and the generation of corresponding logical qubit, gate, and gate dependency lists, according to some embodiments.

FIG. 4 illustrates an example format of a layout-transition-based order encoding scheme that may be used by a SAT solver, according to some embodiments.

FIG. 5A illustrates an example of a mapping of the logical quantum circuit shown in FIG. 3B to a quantum hardware device that has the physical qubit connectivity graph shown in FIG. 3A, wherein the mapping has been resolved using 5 SWAP gates, according to some embodiments.

FIG. 5B illustrates an example of a part of a result of a SAT solver for a mapping of the logical quantum circuit shown in FIG. 3B to a quantum hardware device that has the physical qubit connectivity graph shown in FIG. 3A, wherein the mapping has been resolved using 5 SWAP gates and the mapping has been encoded using a layout-transition-based order encoding scheme, according to some embodiments.

FIG. 6 illustrates an example of a mapping of the logical quantum circuit shown in FIG. 3B to a quantum hardware device that has the physical qubit connectivity graph shown in FIG. 3A, wherein the mapping has been resolved using 4 SWAP gates, according to some embodiments.

FIG. 7 illustrates an example of a mapping of the logical quantum circuit shown in FIG. 3B to a quantum hardware device that has the physical qubit connectivity graph shown in FIG. 3A, wherein the mapping has been resolved using 3 SWAP gates, according to some embodiments.

FIG. 8 is a flowchart illustrating a process of generating a quantum circuit mapping (e.g., to be used for executing a quantum circuit using a given quantum hardware device) by encoding the quantum circuit mapping as a SAT solver problem, according to some embodiments.

FIG. 9 illustrates edge computing devices of a quantum computing service physically located at quantum hardware provider locations, according to some embodiments.

FIG. 10 illustrates an example edge computing device connected to a quantum computing service, according to some embodiments.

FIG. 11 illustrates example interactions between a quantum computing service and an edge computing device of the quantum computing service, according to some embodiments.

FIG. 12 is a block diagram illustrating an example classical computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods and apparatus for enabling a logical quantum circuit to be executed on a given quantum hardware device according to said quantum hardware device's physical qubit connectivity graph (also referred to as a qubit interaction graph). Such a process may be referred to herein as a quantum circuit mapping. In some embodiments, logical computation that may be required to execute the logical quantum circuit may utilize more physical qubits than are available on the given quantum hardware device, and/or the logical computation may not be conducive to a given configuration of physical qubits and connected edges (also called a physical qubit connectivity graph). For example, a logical computation may assign for a gate to be performed between two physical qubits on a quantum hardware device which are not physically connected via an edge. In such cases, a “SWAP operation” (e.g., a SWAP gate) may be used to logically exchange the quantum states between two respective physical qubits, allowing for a circumvention of some physical limitations of the given quantum hardware device.

While SWAP operations (e.g., a SWAP gate) may extend the capability of a given quantum hardware device for executing logical operations by allowing for certain qubit states to be logically re-mapped, such SWAP operations may increase a duration of time required to execute a given logical quantum circuit. For example, a SWAP gate comprises three CNOT gates, which adds time to a total execution time of a logical quantum circuit. Furthermore, the three CNOT gates may introduce additional error and/or noise (e.g., crosstalk), and may therefore introduce additional difficulty in error correction of the quantum circuit. Therefore, it may be advantageous to minimize a number of SWAP operations (e.g., SWAP gates) that are implemented in a given quantum circuit mapping.

Solving for (e.g., generating an assignment wherein a given logical quantum circuit may be mapped to a physical qubit layout of a given quantum hardware device and executed using said quantum hardware device) and optimizing (e.g., minimizing a number of SWAP gates) a given quantum circuit mapping problem may be considered as an NP-hard (also referred to as NP-complete) optimization problem, and therefore a particular method and/or approach to encoding such NP-hard problems may have importance. In the past, heuristic approaches and/or SMT solving approaches were used to solve such NP-hard quantum circuit mapping problems. Such approaches produce a single encoding that requires a given solver to find the absolute minimization of all parameters. Given the difficulty of solving such NP-hard quantum circuit mapping problems, this requires substantial time and compute resources, and may fail to return any answer in a reasonable amount of time.

Rather than risk a lengthy and slow NP-hard minimization problem, the methods and apparatus described herein relate to using SAT solving to solve for quantum circuit mapping problems. By providing SAT solvers with encoded quantum circuit mapping problems using a binary formalism, the SAT solvers may solve for simpler problems, which leads to faster results. Furthermore, rather than solving for a minimal number of SWAP gates that are required to generate a given quantum circuit mapping, a SAT solver may instead be asked to solve a simpler problem of determining whether or not there exists at least one assignment in which a given quantum circuit mapping may be generated using at most a given number of SWAP gates the SAT solver is provided with. In some embodiments, such a number may be requested by a customer of a cloud-based compilation service, as described in the following paragraphs.

In some embodiments, a cloud-based compilation system may also leverage multiple SAT solving compute instances in order to run multiple encoded quantum circuit mapping problems (e.g., each problem with a different number of SWAP gates to solve using) simultaneously, again speeding up a process of generating a quantum circuit mapping. For example, such SAT solving methods as described herein may be used to find a minimum (and/or an approximate minimum) number of SWAP gates required to generate a quantum circuit mapping by attempting to solve using multiple quantities of SWAP gates in parallel, which may allow a minimum to be found faster than if an absolute minimum was attempted via SMT solving. Such parallel SAT solving techniques may also be computationally cheaper than an SMT-based optimization problem.

In some embodiments, a SAT solver may be described as a tool for finding solutions to constraints given a finite set of solutions. A problem, such as a quantum circuit mapping problem, may be encoded as a SAT solver problem such that a SAT solver determines one or more of said finite set of solutions. A SAT solver may also determine that there is no solution that satisfies the given input constraints. Furthermore, a SAT solver is provided with binary inputs and solves binary constraints: a SAT solver determines that there is a solution that satisfies the given input constraints when there is an assignment that produces a binary “True” to all of the binary constraints.

Using SAT solving to generate quantum circuit mappings, such as those methods described herein, may be more efficient and faster than using other optimization problem solving techniques (e.g., SMT solving) as variables pertaining to the quantum circuit mapping problems are encoded as finite (e.g., bounded) binary variables (e.g., True/False). As such, embodiments described herein relate to encoding quantum circuit mapping problems into a binary formalism such that the problems may be provided to SAT solvers. In order to translate a quantum circuit mapping problem into a binary formalism, the quantum circuit mapping problem may be encoded using a Conjunctive Normal Form (CNF) using a layout-transition-based order encoding scheme (see description with regard to FIG. 4 herein). Methods for receiving inputs related to mapping a given logical quantum circuit to a physical qubit architecture of a given quantum hardware device and using said inputs to encode the mapping problem as a SAT solver problem are additionally disclosed.

In some embodiments, a system includes a service provider network comprising one or more computing devices that are configured to implement services of the service provider network such as a quantum compilation service, a quantum computing service, an optimization problem service, and/or other services that relate to enabling customers of the service provider network to seamlessly use one or more quantum computing technologies to execute logical quantum circuits and/or quantum algorithms. In the methods and apparatus described herein, a quantum algorithm and/or a quantum program may refer to one or more logical quantum circuits. For example, a quantum algorithm may comprise a second logical quantum circuit that depends on an outcome determined via a first logical quantum circuit, etc. In some embodiments, a compilation service may be configured to receive inputs for a given quantum circuit mapping problem and encode said quantum circuit mapping problem as a SAT solver problem. The compilation service may then provide the encoded SAT solver problem to an optimization problem service, wherein the optimization problem service may be configured to implement one or more SAT solving instances which may attempt to solve for the encoded SAT solver problem. The compilation service may then be additionally configured to receive results via communication with the optimization problem service and provide a quantum circuit mapping recommendation based, at least in part, on the received results. In some embodiments, the inputs received by the compilation service may be provided by a quantum computing service, which is described in additional detail in the following paragraphs.

### Example Quantum Computing Service

Quantum computers may be difficult and costly to construct and operate. Also, there are varying quantum computing technologies under development with no clear trend as to which of the developing quantum computing technologies may gain prominence. Thus, potential users of quantum computers may be hesitant to invest in building or acquiring a particular type of quantum computer, as other quantum computing technologies may eclipse a selected quantum computing technology that a potential quantum computer user may invest in. Also, successfully using quantum computers to solve practical problems may require significant trial and error and/or otherwise require significant expertise in using quantum computers.

As an alternative to building and maintaining a quantum computer, potential users of quantum computers may instead prefer to rely on a quantum computing service to provide access to quantum computers. Also, in some embodiments, a quantum computing service, as described herein, may enable potential users of quantum computers to access quantum computers based on multiple different quantum computing technologies and/or paradigms, without the cost and resources required to build or manage such quantum computers. Also, in some embodiments, a quantum computing service, as described herein, may provide various services that simplify the experience of using a quantum computer such that potential quantum computer users lacking deep experience or knowledge of quantum mechanics, may, never the less, utilize quantum computing services to solve problems.

Also, in some embodiments, a quantum computing service, as described herein, may be used to supplement other services offered by a service provider network. For example, a quantum computing service may interact with a classical computing service to execute hybrid algorithms. In some embodiments, a quantum computing service may allow a classical computer to be accelerated by sending particular tasks to a quantum computer for execution, and then further performing additional classical compute operations using the results of the execution of a quantum computing object on the quantum computer. For example, a quantum computing service may allow for the acceleration of virtual machines implemented on classical hardware in a similar manner as a graphics processing unit (GPU) may accelerate graphical operations that otherwise would be performed on a central processing unit (CPU). A quantum computing service may also interact with other services offered by a service provider network such as a compilation service described above.

In some embodiments, a quantum computing service may provide potential quantum computer users with access to quantum computers using various quantum computing technologies, such as quantum annealers, ion trap machines, superconducting machines, Rydberg atom arrays, photonic devices, etc. In some embodiments, a quantum computing service may provide customers with access to at least three broad categories of quantum computers including quantum annealers, circuit-based quantum computers, and analog or continuous variable quantum computers. As used herein, these three broad categories may be referred to as quantum computing paradigms.

In some embodiments, a quantum computing service may be configured to provide simulation services using classical hardware-based computing instances to simulate execution of a quantum circuit on a quantum computer. In some embodiments, a quantum computing service may be configured to perform general simulation and/or simulation that specifically simulates execution of a quantum circuit on a particular type of quantum computer of a particular quantum computer technology type or paradigm type. In some embodiments, simulation may be fully managed by a quantum computing service on behalf of a customer of the quantum computing service. For example, the quantum computing service may reserve sufficient computing capacity on a virtualized computing service of the service provider network to perform simulation without customer involvement in the details of managing the resources for the simulator.

In some embodiments, a quantum computing service may include a dedicated console that provides customers access to multiple quantum computing technologies. Furthermore, the quantum computing service may provide a quantum algorithm development kit that enables customers with varying levels of familiarity with quantum circuit design to design and execute quantum circuits. In some embodiments, a console of a quantum computing service may include various application programmatic interfaces (APIs), such as:
(Create/Delete/Update/Get/List)Simulator-Configuration—create, read, update, and delete (CRUD) operations for simulator configuration objects.
(Start/Cancel/Describe)Simulator—used to control each of the user-defined simulator instances.
(List/Describe) quantum processor units (QPUs)—retrieves quantum computer hardware information.
(Create/Cancel/List/Describe)Job—used to manage the lifecycle of a quantum job.
(Assign/Update/List) Quality of Service (QOS) guarantee—used to manage QoS guarantees for quantum jobs and/or quantum tasks.
(Create/Cancel/List/Describe)Task—used to manage the lifecycle of individual quantum tasks/quantum objects.

In some embodiments, a quantum algorithm development kit may include a graphical user interface, APIs or other interface to allow customers of a quantum computing service to define quantum objects, such as quantum tasks, algorithms or circuits, using the quantum algorithm development kit. In some embodiments, the quantum algorithm development kit may include an interface option that enables customers to share the quantum objects with other customers of the quantum computing service. For example, the quantum algorithm development kit may include a marketplace that allows customers to share or sell particular quantum objects with other customers. In some embodiments, the quantum algorithm development kit may include an interface element that allows customers to select a QoS to be applied for a quantum job or quantum tasks defined via the quantum algorithm development kit.

In some embodiments, a quantum computing service may include a public application programmatic interface (API) that accepts quantum objects submitted by a customer of the quantum computing service. In some embodiments, the quantum computing service may accept via the public API, or another API, instructions regarding a QoS guarantee to be used for one or more quantum jobs or quantum tasks, such as executing the quantum object received via the public API. Additionally, the quantum computing service may include a back-end API transport that is non-public. The back-end API transport may enable quantum circuits to be transported from a centralized location that implements the quantum computing service, such as one or more data centers of a service provider network, to an edge computing device at a particular quantum hardware provider location where the quantum circuit is to be executed. In some embodiments, quantum objects or quantum tasks may be executed using an internal QPU of the quantum computing service without using a back-end API transport to transport the quantum job or quantum task to an external quantum hardware provider location.

In some embodiments, results of the execution of a quantum circuit on a quantum computer at a quantum hardware provider location may be provided to the edge computing device at the quantum hardware provider location. The edge computing device may automatically transport the results to a secure storage service of the service provider network, where the customer can access the results using the storage service of the service provider network or via a console of the quantum computing service. Likewise, results of execution of a quantum circuit via an internal QPU may be accessed via the console of the quantum computing service.

In some embodiments, the results stored to the secure storage service may be seamlessly used by other services integrated into the service provider network, such as a machine learning service, a database service, an object-based storage service, a block-storage service, a data presentation service (that reformats the results into a more usable configuration), etc. For example, in some embodiments, a machine learning service may be used to optimize a quantum algorithm or quantum circuit. For example, the machine learning service may cause various versions of a quantum algorithm or quantum circuit to be run on a quantum computer via a quantum computing service. The machine learning service may also be provided access to results of running the quantum algorithms or quantum circuits. In some embodiments, the machine learning service may cause the quantum algorithms or quantum circuits to be run on various different quantum computing technology-based quantum computers. Based on the results, the machine learning service may determine one or more optimizations to improve the quantum algorithms or quantum circuits.

In some embodiments, a quantum computing service may support creating snapshots of results of executing a quantum circuit. For example, the quantum computing service may store snapshots of intermediate results of a hybrid algorithm or may more generally store snapshots of any results generated by executing a quantum circuit on a quantum computer. In some embodiments, an edge computing device at a hardware provider location may temporarily store results and may create snapshot copies of results stored on the edge computing device. The edge computing device may further cause the snapshot copies to be stored in an object-based data storage service of the service provider network. In some embodiments, snapshotting may not be performed, based on customer preferences.

Furthermore, as related to the description herein, it may be understood that quantum hardware, such as quantum hardware device(s), may be used to implement quantum computers, and/or various components of quantum computers (e.g., quantum processing units/cores (QPUs), routing spaces, magic state distillation factories, other components used to perform logical quantum computations, etc.). For example, a given quantum hardware device may resemble “building blocks” of a quantum computer, such as a grid (e.g., a one-dimensional grid, a two-dimensional grid, etc.) of qubits that may be initialized in various ways in order to form various components of a quantum computer, such as topological quantum codes. Quantum hardware devices may be further configured such that single qubit gates, multi-qubit gates, and/or other operations of quantum circuits may be performed between qubits of the quantum hardware devices (according to a given physical qubit connectivity graph of the quantum hardware device which details which physical qubits are connected to respective other physical qubits via edges). A person having ordinary skill in the art should also understand that, depending upon factors such as type(s) of qubit technologies used, type(s) of gates performed between said qubits, etc., quantum hardware devices may also comprise various control devices (e.g., function generators, devices for temperature, magnetic, and/or other environmental controls pertaining to local environments of the grid of qubits, etc.) that may be used to maintain and/or transform various properties of the qubits and/or other physical components of a given quantum computer. Moreover, a person having ordinary skill in the art should understand that a qubit may refer to both a logical bit (e.g., a one or a zero with some probability) and to one or more physical components used to construct the given qubit based, at least in part, on the type of qubit technology being applied. For example, a superconducting qubit (e.g., a transmon) may be constructed using at least a superconducting material and a non-superconducting material in which the non-superconducting material is located in between sections of superconducting material. With regard to this understanding, it should also be understood that quantum hardware may therefore be used to implement physical qubits, in ways such as those as described above, that may again be combined in various ways to implement one or more logical qubits such that logical quantum operations may be performed using said physical elements of said quantum hardware.

### Example Services and Interactions of a Service Provider Network

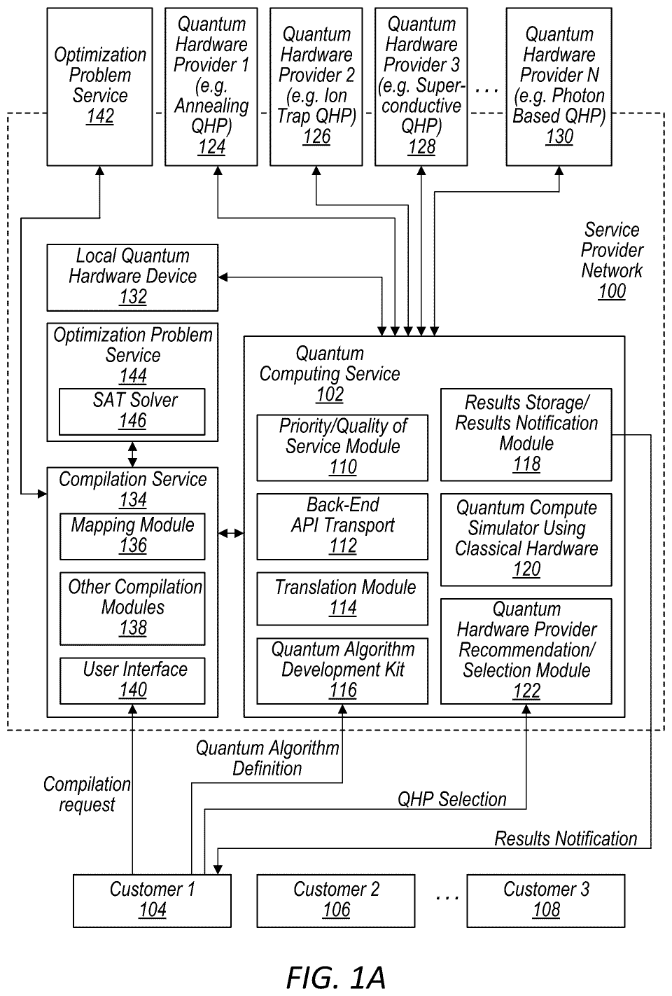

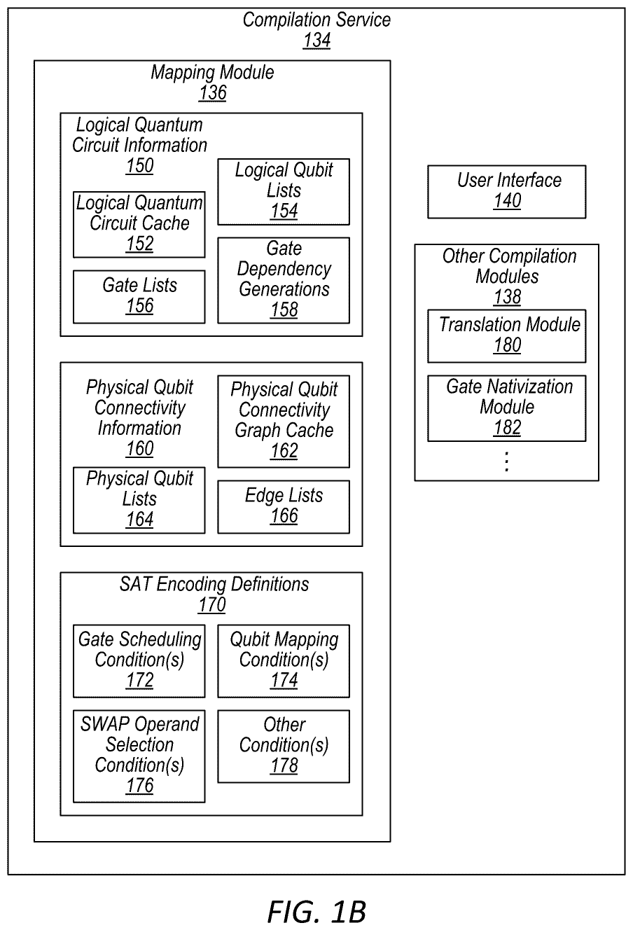

FIG. 1A illustrates a service provider network that enables customers to compile and execute quantum circuits using multiple quantum computing technologies, and FIG. 1B illustrates a compilation service of the service provider network that enables customers to compile and generate mappings of logical quantum circuits to quantum hardware devices, according to some embodiments.

In some embodiments, service provider network 100 may include various services such as quantum computing service 102, compilation service 134, and optimization problem service 144, in addition to one or more other services that pertain to quantum compilation and computation. In some embodiments, service provider network 100 may include data centers, routers, networking devices, etc., such as of a cloud computing provider network. In some embodiments, customers 104, 106, and 108 and/or additional customers of service provider network 100 and/or quantum computing service 102, may be connected to the service provider network 100 in various ways, such as via a logically isolated connection over a public network, via a dedicated private physical connection, not accessible to the public, via a public Internet connection, etc.

In some embodiments, service provider network may include compilation service 134. Compilation service 134 may orchestrate one or more intermediate compilations (e.g., a compilation mapping of a logical quantum circuit to a given quantum hardware device structure, a compilation of gate nativization(s), translation of a quantum circuit into a quantum circuit specific to a given quantum hardware provider's design/language/architecture/technology, etc.) that may be used in order to take an input logical quantum circuit and conduct the execution of said circuit using a given quantum hardware device of a given quantum hardware provider. Customers of service provider network 100 (e.g., customers 104, 106, 108, etc.) may interact with compilation service 134 in order to submit compilation requests, according to some embodiments.

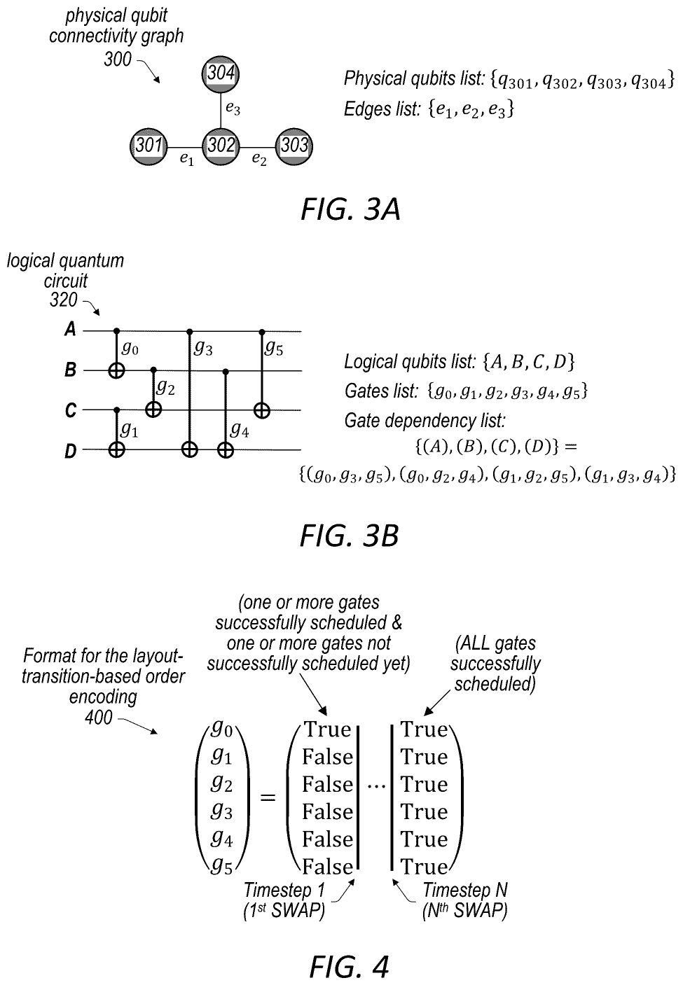

In some embodiments, mapping module 136 may be used to encode a quantum circuit mapping as an optimization problem, such as a SAT solver problem. Logical quantum circuit information 150 and physical qubit connectivity information 160 may be used to receive and store inputs and information pertaining to quantum circuit mappings generated via compilation service 134, according to some embodiments. Such inputs may be submitted via user interface 140 (see description pertaining to interface 200 herein). For example, logical quantum circuit cache 152 may be configured to store logical quantum circuits (e.g., logical quantum circuit 320) of one or more customers of compilation service 134, and logical qubit lists 154 and gate lists 156 may be configured to store lists of logical qubits and gates that correspond to respective logical quantum circuits (see also description with regard to FIG. 3B herein). In order to encode a quantum circuit mapping problem as a SAT solver problem, a gate dependency list may be generated, based on a given logical quantum circuit stored in logical quantum circuit cache 152, as part of said encoding process, according to some embodiments. Such gate dependency generations may be stored in gate dependency generations 158, according to some embodiments. In another example, physical qubit connectivity graph cache 162 may be configured to store physical qubit connectivity graphs (e.g., physical qubit connectivity graph 300) of one or more quantum hardware devices of quantum hardware providers (e.g., quantum hardware providers 124, 126, 128, 130) and/or physical qubit connectivity graphs provided by customers of compilation service 134. Physical qubit lists 164 and edge lists 166 may be configured to store lists of physical qubits and edges that correspond to respective physical qubit connectivity graphs. In some embodiments, in order to encode a quantum circuit mapping problem as a SAT solver problem, a physical qubit and edge lists may be generated, based on a given physical qubit connectivity graph stored in physical qubit connectivity graph cache 162, as part of said encoding process.

In some embodiments, compilation service 134 be configured to use information in logical quantum circuit information 150 and physical qubit connectivity information 160, and a layout-transition-based order encoding scheme defined via SAT encoding definitions 170 in order to generate a CNF equation that represents a given quantum circuit mapping problem. SAT encoding definitions 170 may include one or more conditions, constraints, and/or other definitions used to encode quantum circuit mapping problems as SAT solver problems, such as gate scheduling condition(s) 172, qubit mapping condition(s) 174, SWAP operand selection condition(s) 176, and/or other condition(s) 178, according to some embodiments. Additional examples of SAT encoding definitions pertaining to a layout-transition-based order encoding scheme are further described with regard to FIG. 4 herein.

An encoded SAT solver problem may then be provided by compilation service 134 to an optimization problem service (e.g., optimization problem service 142, optimization problem service 144, etc.) such that the encoded SAT solver problem may be executed using a SAT solver (e.g., SAT solver 146). In some embodiments, an optimization problem service may be configured to implement SAT solving instances, in addition to instances of other optimization problem solving techniques (e.g., SMT solving, heuristic solving approaches, etc.).

Compilation service 134 may also orchestrate and/or coordinate the execution of the encoded SAT solver problem. For example, compilation service 134 may request certain compute resources, a time allocation, etc. in order to enable the execution of the encoded SAT solver problem using an optimization problem service. In some embodiments, compilation service 134 may communicate with optimization problem service 144 within service provider network 100 in order to coordinate the execution of a given encoded SAT solver problem using a SAT solving instance of SAT solver 146. In some embodiments, compilation service 134 may be configured to communicate with one or more other optimization problem services accessible via service provider network 100, such as optimization problem service 142, in which the optimization problem service may be located at a premises outside of service provider network 100. In such embodiments, compilation service 134 may communicate with optimization problem service 142 via an edge computing device physically located at a premises of optimization problem service 142 such that service provider network 100 may be extended. In some embodiments in which multiple encoded SAT solver problems are submitted for execution using SAT solving techniques, compilation service 134 may be further configured to coordinate the execution of said problems using multiple optimization problem services in order to conduct said executions more efficiently.

Compilation service 134 may also include one or more additional modules (e.g., other compilation modules 138). For example, translation module 180 may be configured to translate non-Clifford operations of a logical quantum circuit into a series of Clifford operations, and/or be configured to perform one or more other intermediate translations pertaining to a target quantum hardware provider. In another example, some two-qubit gates of a logical quantum circuit may be decomposed into a series of native gates, and gate nativization module 182 may be configured to treat such decompositions. In yet another example, in some embodiments in which a quantum hardware provider of quantum hardware providers 124-130 pertains to Rydberg atom arrays, other compilation modules 138 may include a module configured to compile and/or encode a mapping problem for determining atomic computational positions in Rydberg atom arrays, according to some embodiments.

Service provider network 100 also includes quantum computing service 102. In some embodiments, a quantum computing service 102 may include a quality of service (QoS) and out-of-band prioritization module 110, a quantum algorithm development kit 116, a translation module 114, and a quantum compute simulator using classical hardware 120. Also, quantum computing service 102 is connected to quantum hardware providers 124, 126, 128, and 130. In some embodiments, quantum hardware providers 124, 126, 128, and 130 may offer access to run quantum objects on quantum computers that operate based on various different types of quantum computing technologies or paradigms, such as based on quantum annealing, ion-trap, superconductive materials, photons, etc.

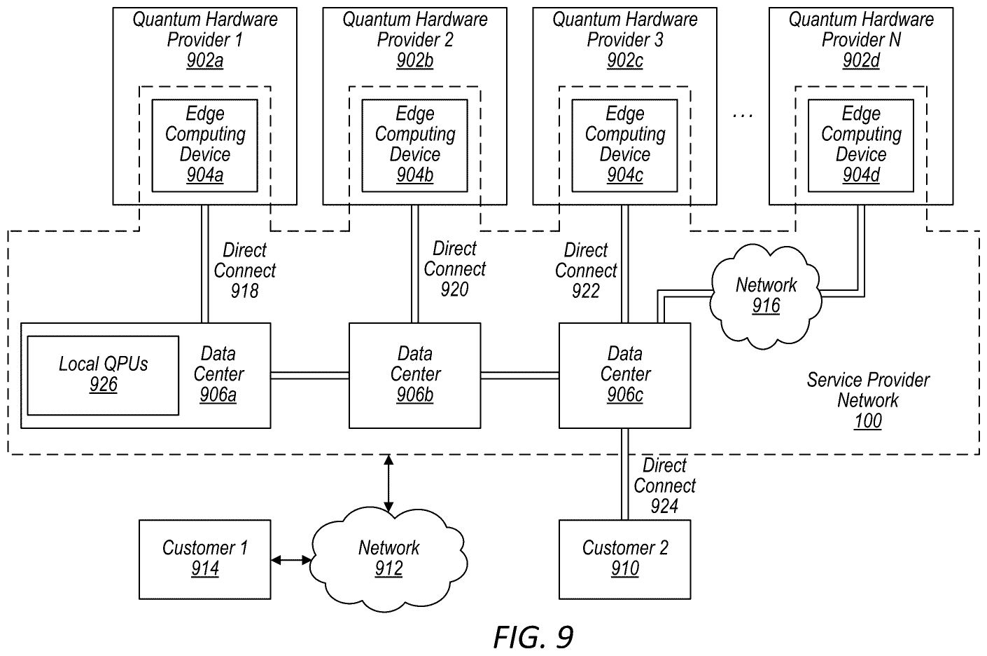

As discussed in additional detail in FIG. 9, in some embodiments, a service provider network 100 may be extended to include one or more edge computing devices physically located at quantum hardware provider locations, such as in a facility of quantum hardware providers 124, 126, 128, and 130. Physically locating (e.g., co-locating) an edge computing device of a service provider network 100 on premises at a quantum hardware provider facility may extend data security and encryption of the service provider network 100 into the quantum hardware providers 124, 126, 128, and 130 facilities, thus ensuring the security of customer data. Also, physically locating an edge computing device of a service provider network 100 on premises at a quantum hardware provider facility may reduce latency between a compute instance of the service provider network and a quantum computer located at the quantum hardware provider facility. Thus, some applications, such as hybrid algorithms that are sensitive to network latencies may be performed by quantum computing service 102, whereas other systems without co-located classical compute capacity at a hardware provider location may have too high of latencies to perform such hybrid algorithms efficiently.

In some embodiments, quantum computing service 102 includes one or more back-end API transport modules 112. In some embodiments, a back-end API transport module 110 may be primarily implemented on edge computing devices of the quantum computing service that are located at the quantum hardware provider locations (such as edge computing devices 904a, 904b, 904c, and 904d illustrated in FIG. 9). Also, in some embodiments, at least some of the back-end API transport functionality may be implemented on the one or more computing devices of the service provider network that implement the quantum computing service (such as computing devices in data center 906a, 906b, 906c illustrated in FIG. 9). In some embodiments, different quantum hardware providers may require different back-end API transport modules, which may further add variability to execution durations of quantum tasks. Some quantum hardware providers may accept quantum tasks over a network via an API such that it is not necessary for the provider network to locate an edge computing device at the quantum hardware provider's facility in order to submit quantum tasks. In some embodiments, some quantum hardware providers may follow a first in first out (FIFO) execution model for quantum tasks submitted for execution to the quantum hardware provider. Other quantum hardware providers may follow a batch execution model. In order to deal with these execution duration variabilities and to further deal with execution duration variability due to characteristics of various quantum tasks (e.g. number of shots, quantum circuit size, number of gates, time to switch between quantum circuits, etc.), a priority access control plane may order quantum tasks submitted to the back-end API transports for various quantum hardware providers in a prioritized order such that quality of service (QOS) guarantees and other scheduling rules are followed.

Quantum computing service 102 is also configured to translate a given quantum computing object into a selected quantum circuit format for a particular quantum computing technology used by the selected quantum hardware provider or internal QPU, wherein the selected quantum circuit format for the particular quantum computing technology is one of a plurality of quantum circuit formats for a plurality of different quantum computing technologies supported by the quantum computing service. To translate the quantum computing object into the selected quantum circuit format, the one or more computing devices that implement the quantum computing service are configured to identify portions of the quantum computing object corresponding to quantum operators in an intermediate representation in which the quantum object was submitted by the customer, substitute the quantum operators of the intermediate representation with quantum operators of the quantum circuit format of the particular quantum computing technology, and perform one or more optimizations to reduce an overall number of quantum operators in a translated quantum circuit that is a translated version of the received quantum computing object. Additionally, quantum computing service 102 may be configured to provide the translated quantum circuit for execution at a quantum hardware provider or internal QPU that uses the particular quantum computing technology; receive, from the quantum hardware provider or internal QPU, results of the execution of the translated quantum circuit; and provide a notification to a customer of the quantum computing service that the quantum computing object has been executed.

Quantum circuits that have been translated by translation module 114 may be provided to back-end API transport module 112 in order for the translated quantum circuits to be transported to a quantum computer at a respective quantum hardware provider location. In some embodiments, back-end API transport 112 may be a non-public API that is accessible by an edge computing device of service provider network 100, but that is not publicly available. In some embodiments, a quality of service (QOS) and out-of-band prioritization module 110 may manage which quantum tasks are submitted to the back-end API transport and in what order. In some embodiments, edge computing devices at the quantum hardware providers 124, 126, 128, and 130 may periodically ping a quantum computer service side interface to the back-end API transport 112 to determine if there are any quantum circuits (or batches of quantum circuits) waiting to be transported to the edge computing device. If so, the edge computing device may perform an API call to the back-end API transport 112 to cause the quantum circuit to be transported over a private connection to the edge computing device and scheduled for execution on a quantum computer. Also, the edge computing device may have been configured with a quantum machine image that enables the edge computing device to interface with a scheduling application of the quantum hardware provider, where the edge computing device is located, in order to schedule a time slot on the quantum computer of the quantum hardware provider to execute the quantum circuit via the back-end API transport 112.

In some embodiments, results of executing the quantum circuit on the quantum computer at the quantum hardware provider location may be returned to the edge computing device at the quantum hardware provider location. The edge computing device and/or quantum computing service 102 may cause the results to be stored in a data storage system of the service provider network 100. In some embodiments, results storage/results notification module 118 may coordinate storing results and may notify a customer, such as customer 104, that the results are ready from the execution of the customer's quantum object, such as a quantum task, quantum algorithm, or quantum circuit. In some embodiments, results storage/results notification module 118 may cause storage space in a data storage service to be allocated to a customer to store the customer's results. Also, the results storage/results notification module 118 may specify access restrictions for viewing the customer's results in accordance with customer preferences.

In some embodiments, quantum compute simulator using classical hardware 120 of quantum computing service 102 may be used to simulate a quantum algorithm or quantum circuit using classical hardware. For example, one or more virtual machines of a virtual computing service may be instantiated to process a quantum algorithm or quantum circuit simulation job. In some embodiments, quantum compute simulator using classical hardware 120 may fully manage compute instances that perform quantum circuit simulation. For example, in some embodiments, a customer may submit a quantum circuit to be simulated and quantum compute simulator using classical hardware 120 may determine resources needed to perform the simulation job, reserve the resources, configure the resources, etc. In some embodiments, quantum compute simulator using classical hardware 120 may include one or more “warm” simulators that are pre-configured simulators such that they are ready to perform a simulation job without a delay typically involved in reserving resources and configuring the resources to perform simulation.

In some embodiments, quantum computing service 102 includes quantum hardware provider recommendation/selection module 122. In some embodiments, quantum hardware recommendation/selection module 122 may make a recommendation to a quantum computing service customer as to which type of quantum computer or which quantum hardware provider to use to execute a quantum object submitted by the customer. Additionally, or alternatively, the quantum hardware provider recommendation/selection module 122 may receive a customer selection of a quantum computer type and/or quantum hardware provider to use to execute the customer's quantum object, such as a quantum task, quantum algorithm, quantum circuit, etc. submitted by the customer or otherwise defined with customer input. In some embodiments, the recommendation may include estimated costs, error rates, run-times, etc. associated with executing the quantum computing object on quantum computers of respective ones of the quantum hardware providers or an internal QPU.

In some embodiments, a recommendation provided by quantum hardware provider recommendation/selection module 122 may be based on one or more characteristics of a quantum object submitted by a customer and one or more characteristics of the quantum hardware providers supported by the quantum computing service 102, such as one or more of quantum hardware providers 124, 126, 128, or 130.

In some embodiments, quantum hardware provider recommendation/selection module may make a recommendation based on known data about previously executed quantum objects similar to the quantum object submitted by the customer. For example, quantum computing service 102 may store certain amounts of metadata about executed quantum objects and use such metadata to make recommendations. In some embodiments, a recommendation may include an estimated cost to perform the quantum computing task by each of the first and second quantum hardware providers. In some embodiments, a recommendation may include an estimated error rate for each of the first and second quantum hardware providers in regard to performing the quantum computing task. In some embodiments, a recommendation may include an estimated length of time to execute the quantum computing task for each of the first and second quantum hardware providers. In some embodiments, a recommendation may include various other types of information relating to one or more quantum hardware providers or any combination of the above.

In some embodiments, quantum compute simulator using classical hardware 120 may allow a customer to simulate one or more particular quantum computing technology environments. For example, a customer may simulate a quantum circuit in an annealing quantum computing environment and an ion trap quantum computing environment to determine simulated error rates. The customer may then use this information to make a selection of a quantum hardware provider to use to execute the customer's quantum circuit.

### Example Usage of a Compilation Service for Encoding a Quantum Circuit Mapping Problem as a SAT Solver Problem

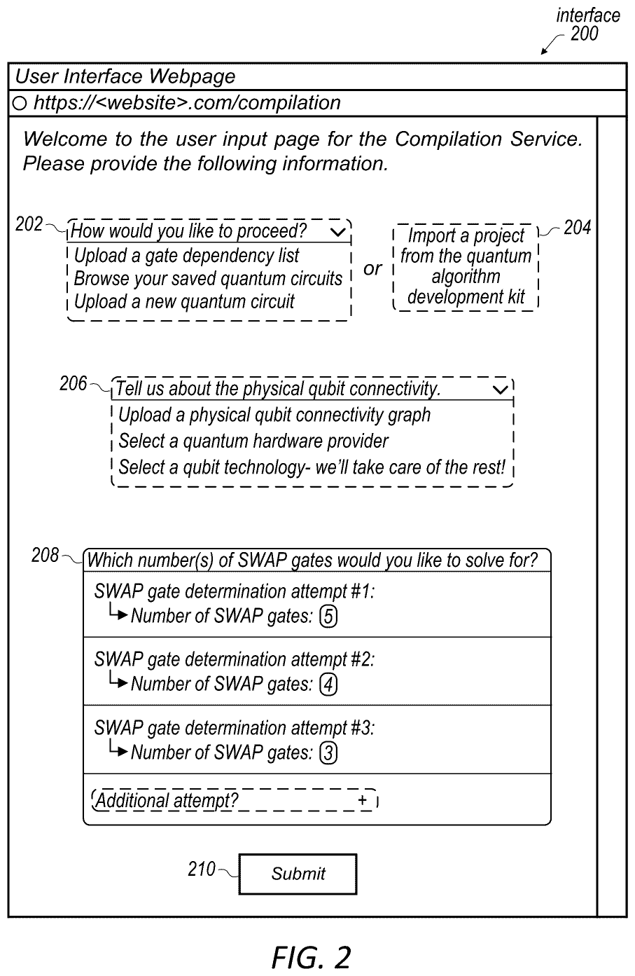

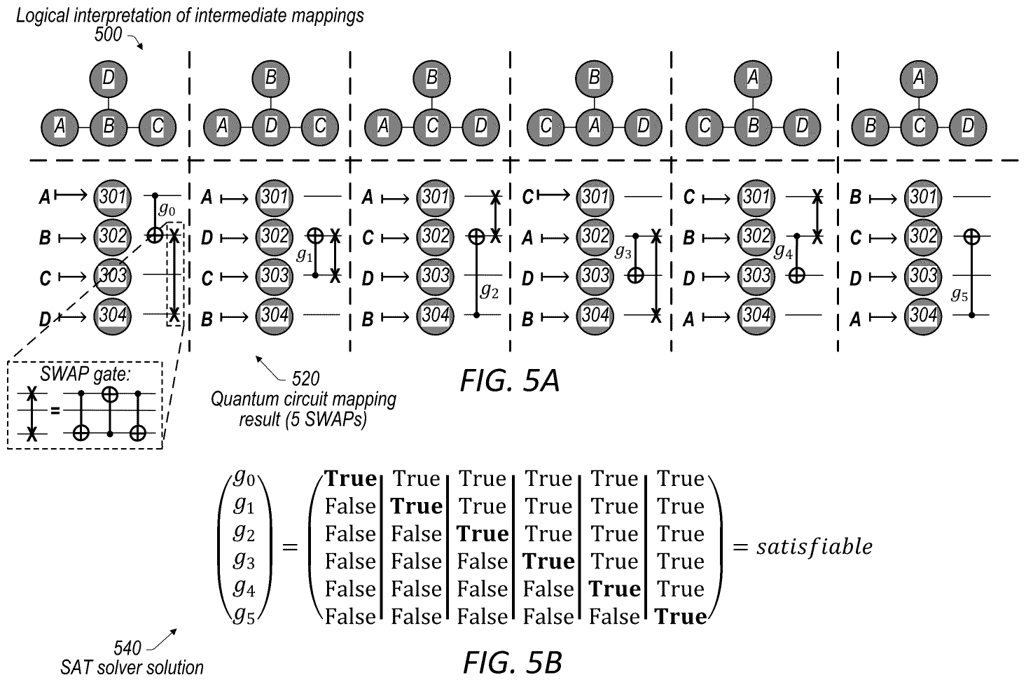

The following figures (FIGS. 2-7) provide example embodiments of how compilation service 134 may be used to encode and solve for a quantum circuit mapping problem, including customer interactions (e.g., FIG. 2), preparations for transforming inputs of a quantum circuit mapping problem (e.g., FIGS. 3A-3B) into a SAT solver problem, and example solutions of a SAT solver (e.g., FIGS. 5A-7) based, at least in part, on a layout-transition-based order encoding scheme (e.g., FIG. 4). A person having ordinary skill in the art should understand that the following example embodiments are meant to demonstrate possible configurations of the methods and apparatus described herein and are not meant to be restrictive. For example, given a different quantum circuit mapping problem (e.g., a different physical qubit connectivity graph, a different logical quantum circuit, a different number of SWAP gates to solve for, etc.), a SAT solver may find some of the same and/or different results (e.g., given a different physical qubit connectivity graph, 3, 4, and 5 SWAP gates may or may not have possible assignments that the SAT solver may determine are solutions to the given quantum circuit mapping problem).

FIG. 2 illustrates an example of a web-based implementation of a user interface of the compilation service, according to some embodiments.

In some embodiments, interface 200 may be implemented as a web-based graphical user interface, wherein a customer of service provider network 100 may upload and/or provide compilation service 134 with various information regarding a request for a quantum circuit mapping that the customer would like completed.

In some embodiments, interface 200 includes box 202 in which a customer is asked what type(s) of inputs they can provide for the quantum circuit mapping request. As introduced above, in order for compilation service 134 to prepare a quantum circuit mapping problem as a SAT solver problem, compilation service 134 should receive and/or generate at least the following: a gate dependency list (see FIG. 3B); lists of physical qubits included in the target quantum hardware device and how respective ones of the physical qubits are connected via edges (see FIG. 3A); and an indication of a number of SWAP gates the customer would like for the SAT solver to attempt to use when solving. A customer may click on various options in fields 202, 204, 206, and 208 in order to provide said inputs directly and/or other inputs (e.g., logical quantum circuit information and/or physical qubit connectivity information) that compilation service 134 may use to generate the above inputs for the quantum circuit mapping problem.

In field 202, a customer may click on various options such as “upload a gate dependency list,” in which a gate dependency list that corresponds to an order in which gates of the given logical quantum circuit are to be performed in (which is sometimes also ordered by logical qubit) may be uploaded. An example of a gate dependency list is shown in FIG. 3B herein. The uploaded gate dependency list may then be stored in gate dependency generations 158, according to some embodiments. A customer may instead decide to click on “browse your saved quantum circuits,” in which a logical quantum circuit which has been stored in logical quantum circuit cache 152 may be used to fulfill the current request shown in interface 200, according to some embodiments. As another option, a customer may click on “upload a new quantum circuit,” in which a customer may upload a logical quantum circuit such as logical quantum circuit 320. The uploaded logical quantum circuit may then be stored in logical quantum circuit cache 152 and used by compilation service to generate a gate dependency list, according to some embodiments.

Alternatively, a customer of compilation service 134 may additionally be a customer of quantum computing service 102, and therefore may click on field 204 to import a project from quantum computing service 102. For example, a customer may have a quantum algorithm project (wherein the given quantum algorithm comprises one or more quantum circuits that represent intermediate logical computations of the overall quantum algorithm) stored with quantum computing service 102 and may request that a quantum circuit mapping be solved for using compilation service 134.

In field 206, a customer may click on various options such as “upload a physical qubit connectivity graph.” An example of a physical qubit connectivity graph is shown in FIG. 3A herein. The uploaded physical qubit connectivity graph may then be stored in physical qubit connectivity graph cache 162, according to some embodiments. As introduced above, if a customer of compilation service 134 is also a customer of quantum computing service 102, they may be able to click on “select a quantum hardware provider,” and select a quantum hardware provider accessible via service provider network 100 (e.g., quantum hardware providers 124, 126, 128, 130, etc.). If the customer selects such an option, compilation service 134 may communicate with quantum computing service 102 in order to obtain information associated with the selected quantum hardware provider (e.g., a layout of a particular quantum hardware device, a physical qubit connectivity graph of a particular quantum hardware device, a list of physical qubits and edges for a particular quantum hardware device, etc.), according to some embodiments. Similarly, if a customer selects “select a qubit technology-we'll take care of the rest!” then compilation service 134 may communicate with quantum hardware provider recommendation 122 of quantum computing service 102 in order to recommend one or more quantum hardware providers to the customer, and, upon selection of one of the recommended quantum hardware providers, quantum computing service 102 may then provide physical qubit connectivity information pertaining to a quantum hardware device of the recommended quantum hardware provider to compilation service 134.

In some embodiments, certain combinations of inputs to fields 202, 204, and 206 may depend on one another and therefore certain subfields of fields 202, 204, and/or 206 may or may not be offered depending on selections of the customer. For example, if a customer selects field 204 to import a project from quantum computing service 102, they may not also be able to select an option in field 202. In a second example, if a customer selects field 204 to import a project from quantum computing service 102, information imported from quantum computing service 102 about the particular project may already include information about the targeted quantum hardware provider, and therefore the customer may not be provided with the options in field 206, as compilation service 134 may already have enough information to fulfill the given quantum circuit mapping request due to the imported project information selection in field 204.

In field 208, a customer may provide one or more quantities of SWAP gates that they want to submit within their request. Each “attempt,” as shown in field 208 will serve as a distinct Conjunctive Normal Form (CNF) equation that is provided to a SAT solver (see blocks 810, 812, 814, and 816 described herein), which may then be performed in parallel (e.g., depending on computing resources of the one or more SAT solvers being allocated to complete the attempt(s) associated with this request).

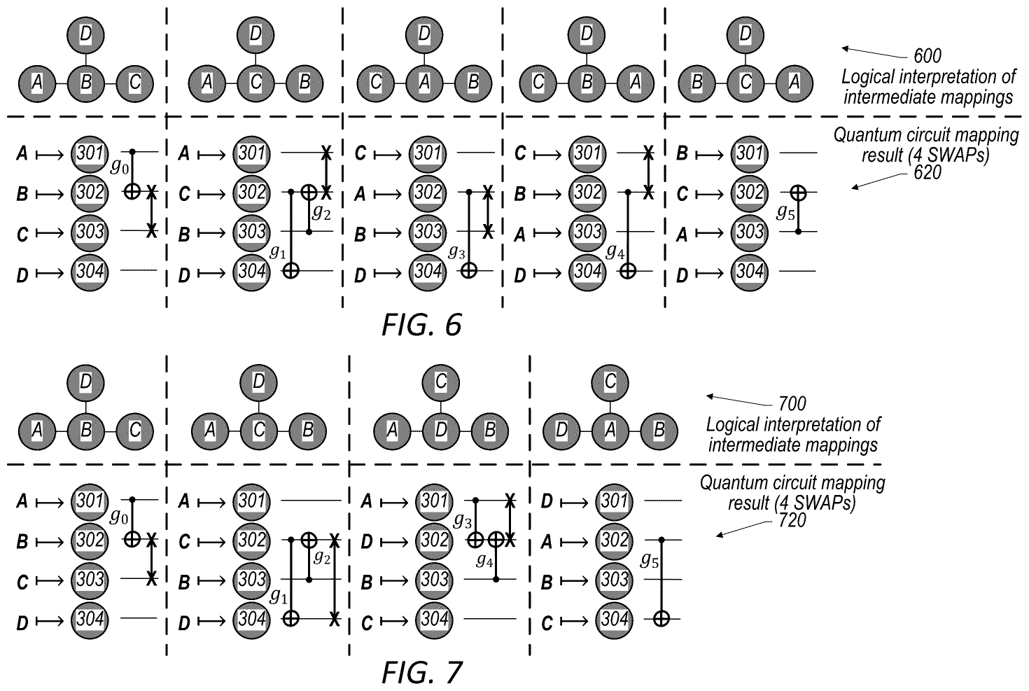

A customer may request one or more quantities of SWAP gates to be attempted to be solved for by the SAT solver. For example, as shown in field 208, the customer has requested that the given encoded quantum circuit mapping problem be attempted using 5, 4, and 3 SWAP gates. FIGS. 5A-7 depict quantum circuit mapping results using the inputs shown in FIGS. 2, 3A, and 3B, wherein FIG. 5A depicts one mapping solution that implements exactly 5 SWAP gates. A person having ordinary skill in the art should understand that FIG. 5A is meant to demonstrate that at least one solution is possible using 5 SWAP gates, and that other solutions may be possible. Similarly, FIG. 6 depicts one mapping solution that implements exactly 4 SWAP gates, and FIG. 7 depicts one mapping solution that implements exactly 3 SWAP gates.

In other embodiments of field 208, a customer may request only one targeted number of SWAP gates (e.g., a customer may define a maximum number of SWAP gates that a SAT solver is allowed to solve using), or more than three numbers of SWAP gates. In addition, a person having ordinary skill in the art should understand that the numbers entered into field 208 may or may not be consecutive. For example, a customer may not have a prior estimate of a minimum number of SWAP gates that are required to complete a given quantum circuit mapping problem, and therefore may submit 1, 10, and 100 SWAP gates into field 208 during a first request. Continuing with the example, assuming that a SAT solver returns a “satisfiable” result for 10 and 100 SWAP gates and an “unsatisfiable” result for 1 SWAP gate in response to the first request, the customer may then submit a second request that narrows in on a minimum number of SWAP gates required by attempting for the SAT solver to solve the quantum circuit mapping problem using 9, 8, and 7 SWAP gates, and so on.

In another example variation of field 208, a customer may submit a maximum number of SWAP gates that a SAT solver may use to solve for the given quantum circuit mapping problem (e.g., 5 SWAP gates in the example shown in field 208). In such embodiments, compilation service 134 may then pre-process this request by generating CNF equations using 5, 4, 3, 2, and 1 SWAP gates, respectively, for example. Such pre-processing and/or internal processing steps may be “automated” with respect to the viewpoint of the customer. Continuing with the example, assuming that a SAT solver returns a “satisfiable” result for 5, 4, and 3 SWAP gates and an “unsatisfiable” result for 2 and 1 SWAP gates, this may imply that an optimal number of SWAP gates for the given quantum circuit mapping problem is 3 SWAP gates, as this represents the smallest number of SWAP gates that returned a “satisfiable” result (see also block 822 pertaining to a mapping recommendation).

In yet another example variation of field 208, a customer may request to receive one, several, or all mapping assignments to a given quantum circuit mapping problem using a given number of SWAP gates. For example, a customer submitting a request to attempt to solve for the given quantum circuit mapping problem using 5 SWAP gates may request that compilation service 134 return one or more of the total mapping assignments that exist using 5 SWAP gates, assuming that at least one assignment has been found by the SAT solver (e.g., when a SAT solver returns a “satisfiable” result).

After a customer is finished completing a combination of fields 202, 204, 206, and 208, they may use Submit button 210 in order to launch their request to compilation service 134.

In some embodiments, interface 200 may be implemented as a graphical user interface. However, interface 200 may also be implemented as various types of programmatic (e.g., Application Programming Interfaces (APIs)) or command line interfaces to support the methods and systems described herein, according to some embodiments.

Furthermore, interface 200 may be a customer-facing interface (e.g., user interface 140) in which a customer of compilation service 134 may submit inputs to be used for a given quantum circuit mapping problem, such as that which is shown in FIG. 2. Alternatively, a customer (e.g., customer 104, 106, 108, etc.) of quantum computing service 102 may request that a quantum algorithm that they provide to quantum computing service 102 be executed using quantum hardware device(s) of a given quantum hardware provider (e.g., quantum hardware provider 124, 126, 128, 130, etc.). As part of the fulfillment of said request, the quantum algorithm may be divided into one or more logical quantum circuits that represent intermediate logical computations used within the overall quantum algorithm. Those logical quantum circuit(s) may then be provided by quantum computing service 102 to optimization problem service 134 in order to generate quantum circuit mapping(s) of the logical quantum circuit(s) to quantum hardware device(s) of a given quantum hardware provider. In such embodiments, interface 200 may not be a customer-facing interface but rather an interface (e.g., an API) between quantum computing service 102 and compilation service 134.

FIG. 3A illustrates an example of a physical qubit connectivity graph for a given quantum hardware device and the generation of corresponding physical qubit and edge lists, according to some embodiments.

In some embodiments, a description of physical qubit placements and respective connectivities to one another for a given quantum hardware device may resemble physical qubit connectivity graph 300. A person having ordinary skill in the art should understand that physical qubit connectivity graph 300 is used herein as an example, and that physical qubit connectivity graphs corresponding to other quantum hardware devices (e.g., quantum hardware devices provided by quantum hardware providers 124, 126, 128, 130, etc.) may include additional or less physical qubits than the four physical qubits shown in physical qubit connectivity graph 300, and/or may be connected via edges that are placed in configurations other than that which is shown in physical qubit connectivity graph 300.

In some embodiments, physical qubit connectivity graph 300 demonstrates four physical qubits (e.g., physical qubits 301, 302, 303, and 304), wherein physical qubits 301 and 302 are physically connected via edge e₁, physical qubits 302 and 303 are physically connected via edge e₂, and physical qubits 302 and 304 are physically connected via edge e₃. Physical qubit connectivity graph 300 may be used to generate both a list of the physical qubits (e.g., Physical qubits list: {q₃₀₁, q₃₀₂, q₃₀₃, q₃₀₄}) that may be used in order to complete a given quantum circuit mapping, and a list of edges that physically connect respective ones of the physical qubits (e.g., Edges list: ({e₁, e₂, e₃}).

In some embodiments, it may be implicitly understood via physical qubit connectivity graph 300 that the following two-qubit gates may be performed according to the physical layout of the given quantum hardware device represented by physical qubit connectivity graph 300: a two-qubit gate between physical qubits 301 and 302, a two-qubit gate between physical qubits 302 and 303, and a two-qubit gate between physical qubits 302 and 304. Similarly, the following two-qubit gates may not be (directly) performed according to the physical layout represented by physical qubit connectivity graph 300: a two-qubit gate between physical qubits 301 and 304, and a two-qubit gate between physical qubits 303 and 304. If a given logical quantum circuit calls for a two-qubit gate between physical qubits 301 and 304 or between physical qubits 303 and 304 to be performed, a SWAP gate or other indirect method may be used to logically alter the states of two given physical qubits of qubits 301, 302, 303, and 304 in order to perform said gate.

In some embodiments, the above explanation of a physical qubit connectivity graph may be generalized into the following: a given physical qubit connectivity graph may comprise P physical qubits and K connected edges eᵢⱼ for i, j∈(0, P] and i≠j. Such information pertaining to physical qubit connectivity may then be initialized into the following: an ordered list E={d₁, . . . , dₖ, . . . , d_{K}} of edges, wherein each dₖ corresponds to an edge eᵢₖⱼₖ in the given physical qubit connectivity graph comprising P physical qubits and K edges that connect respective ones of the physical qubits. The order of edges eᵢⱼ in E may be chosen arbitrarily. Furthermore, for each dₖ, a larger physical qubit index that said dₖ connects may be written as dₖ. opₘₐₓ and a smaller physical qubit index that is also connected by dₖ may be written as dₖ. opₘᵢₙ, according to some embodiments. Such an initialization of a given physical qubit connectivity graph may be viewed as an initialization step and/or a pre-processing step performed by compilation service 134 in preparation for the given quantum circuit mapping to be encoded as a SAT solver problem.

FIG. 3B illustrates an example of a logical quantum circuit and the generation of corresponding logical qubit, gate, and gate dependency lists, according to some embodiments.

In some embodiments, a logical quantum circuit submitted by a customer of service provider network 100 may resemble logical quantum circuit 320. A person having ordinary skill in the art should understand that logical quantum circuit 320 is used herein as an example, and that logical quantum circuits corresponding to other logical quantum computations may include additional or less logical qubits than the four logical qubits shown in logical quantum circuit 320, and/or may include additional and/or other single or multi-qubit gates other than the six two-qubit gates which are shown in logical quantum circuit 320.

In some embodiments, logical quantum circuit details six two-qubit gates that are to be performed between respective ones of the four logical qubits shown in order to complete a given quantum computation. Logical quantum circuit 320 may be used to generate a list of logical qubits (e.g., Logical qubits list: {A, B, C, D}) and a list of gates that are to be performed between respective ones of said logical qubits (e.g., Gates list: {g₀, g₁, g₂, g₃, g₄, g₅}). A gate dependency list may additionally be generated in which, according to logical quantum circuit 320, gate g₀ must be performed on logical qubit A before gate g₃ is performed on logical qubit A, and gate g₃ must be performed on logical qubit A before gate g₅ is performed on logical qubit A, etc.

In some embodiments, the above explanation of a logical quantum circuit may be generalized into the following: a given logical quantum circuit that is to be used in a quantum circuit mapping may be represented using V logical qubits and an ordered list of n two-qubit gates G={g₀, . . . , gᵢ, . . . , gₙ₋₁}. Such information pertaining to a logical quantum circuit description may then be initialized into the following: for g; in G, a larger gate operand may be denoted as gᵢ. opₘₐₓ and a smaller gate operand may be denoted as gᵢ. opₘᵢₙ, which are then initialized into an array. Both gᵢ. opₘₐₓ and gᵢ. opₘᵢₙ may be fixed for i∈[0, n). Furthermore, a gate dependency list for a generalized logical quantum circuit may be written as l_{g}={(g₁¹, g₂¹), . . . , (g₁ⁱ, g₂ⁱ), . . . }, wherein each pair of gates denotes that g₂ⁱ is dependent on g₁ⁱ and therefore cannot be scheduled before g₁ⁱ. As shown in FIG. 3B for the example of logical quantum circuit 320, l_{g} may be generated by enumerating gate dependencies on each qubit (e.g., {A, B, C, D}={(g₀, g₃, g₅), (g₀, g₂, g₄), (g₁, g₂, g₅), (g₁, g₃, g₄)}). Such an initialization of a given logical quantum circuit be viewed as an initialization step and/or a pre-processing step performed by compilation service 134 in preparation for the given quantum circuit mapping to be encoded as a SAT solver problem.

FIG. 4 illustrates an example format of a layout-transition-based order encoding scheme that may be used by a SAT solver, according to some embodiments.

As introduced above, a quantum circuit mapping may be encoded as a SAT solver problem by applying a layout-transition-based order encoding scheme for mapping quantum circuit, which is further described in the following paragraphs. Such an encoding procedure may utilize the following three inputs in order to prepare a quantum circuit mapping using a SAT solver formulation: (1) a logical quantum circuit which may be represented using V logical qubits and an ordered list of n two-qubit gates G={g₀, . . . , gᵢ, . . . , gₙ₋₁}; (2) a physical qubit connectivity graph which may be represented as having P physical qubits and K connected edges eᵢⱼ for i,j∈(0, P] and i≠j; and (3) a target number of SWAP gates (e.g., S SWAP gates) for the SAT solver to attempt to use when solving for the quantum circuit mapping. As described above with regard to FIGS. 3A and 3B, such inputs may be pre-processed and/or initialized into a list of physical qubits, a list of edges that connect said physical qubits, and a gate dependency list.

In some embodiments as described herein, a quantum circuit mapping problem is encoded as a SAT solver problem using a layout-transition-based order encoding scheme, wherein said scheme may be summarized as the following. A “layout” may refer to the layout of a given quantum hardware device involved in the given quantum circuit mapping problem (e.g., a physical qubit connectivity graph or similar representation that details locations of physical qubits and which respective ones of the physical qubits are connected to other respective ones via edges). The “layout-transition-based” part of the layout-transition-based order encoding scheme is named as such since the temporal encoding of the quantum circuit mapping is done based on layout transition steps which are marked as timesteps (e.g., rather than by qubit measurement and reset timesteps, etc.). As shown in format 400, timesteps 1 through N occur when a transition from one mapping to another occurs (e.g., using a SWAP gate). Each layout update event is therefore encoded as a new timestep.

Examples of SAT solver solutions to a quantum circuit mapping problem defined using physical qubit connectivity graph 300, logical quantum circuit 320, and field 208 are provided in FIGS. 5A, 6, and 7, and FIG. 5B provides an example of format 400 as applied to said quantum circuit mapping problem using quantum circuit mapping result 520. In a particular “satisfiable” result example shown in FIG. 5B, there are five timesteps due to the five mapping transitions caused by the five SWAP gate implementations.

Furthermore, the “order encoding” part of the “layout-transition-based order encoding scheme” is named as such since, for each gate in the matrix (e.g., gates g₀ through g₅ as shown in FIG. 4), a decision of whether the gate is scheduled before the following transition is encoded as a Boolean variable (e.g., True/False, one or zero, etc.). For example, in SAT solver solution 540, gate g₀ has been scheduled before timestep 1 and therefore is encoded with a Boolean value of True in the first column of the matrix, while gates g₁ through g₅ have not been scheduled prior to timestep 1 and therefore are encoded with Boolean values of False in the first column. In the second column of SAT solver solution 540, gate g₁ has additionally been scheduled before timestep 2, and therefore gates g₀ and g₁ are encoded with Boolean values of True, while gates g₂ through g₅ are encoded with Boolean values of False, and so on.

This “order encoding” is additionally represented in format 400, wherein, as an example, gate g₀ has been scheduled before timestep 1, and gates g₁ through g₅ have not been scheduled prior to timestep 1. A person having ordinary skill in the art should understand that this is merely meant to demonstrate example embodiments of format 400, and that additional embodiments of format 400 in which any number of gates greater than or equal to one may be scheduled prior to timestep 1 as long as said number is less than the total number of gates needing to be scheduled (e.g., a total of 6 gates in an example shown in FIG. 4). As additionally shown in format 4, all gates have been successfully scheduled in the last column of format 400 following timestep N, as gates g₀ through g₅ have been encoded with Boolean variables of True. Such embodiments may be referred to as a “satisfiable” result of a SAT solver, as all gates have been encoded with Boolean variables of True in the last column of the given matrix. If, instead, one or more gates have been encoded with Boolean variables of False in the last column of format 400, this may be referred to as an “unsatisfiable” result of the SAT solver.

In some embodiments, format 400 includes a matrix prepared for gates g₀ through g₅ which follows the gates of logical quantum circuit 320. However, a person having ordinary skill in the art should understand that additional implementations of format 400 may include larger or smaller matrices depending on the number of gates in a particular logical quantum circuit and/or the number of transitions (e.g., timesteps) defined by the number of SWAP gates in the particular request for solving for a given quantum circuit mapping.

In some embodiments, a layout-transition-based encoding scheme for SAT solving may have many benefits, including a reduction in a size of a matrix in format 400 with respect to other methods of solving optimization problems that may require encoding timesteps for each operation of each gate within a given quantum circuit mapping problem. For example, only one column between each timestep (e.g., SWAP gate) may be used in format 400 to describe whether or not a given gate has been scheduled or not. This example is also discussed with regard to FIG. 6 herein.

In order to encode a quantum circuit mapping problem as a SAT solver problem, one or more encoding variables may additionally be used when generating the CNF equation that is to be submitted to the SAT solver. Encoding variables as described herein for use in SAT solving refer to Boolean variables. In some embodiments, such encoding variables may resemble the following, in which a generalized quantum circuit mapping problem (see the above description with regard to generalizations of physical qubit connectivity graph 300 and logical quantum circuit 320 in FIGS. 3A and 3B for generalized variable definitions) is being encoded as a SAT solver problem:
A gate scheduling condition (o_{g}_{ᵢ}^{s}): if gate gᵢ is scheduled after SWAP gate number s, wherein s∈[0, S], then o_{g}_{ᵢ}^{s}=True, otherwise o_{g}_{ᵢ}^{s}=False. A given two-qubit gates may only be scheduled after the logical qubit operands corresponding to said gate (e.g., gᵢ. opₘᵢₙ and gᵢ. opₘₐₓ) are mapped to connected physical qubits according to the physical qubit connectivity graph.
A layout/qubit mapping condition (πᵢⱼ^{s}): after SWAP gate number s (and before SWAP gate number s+1 if s<S), if logical qubit i is mapped to physical qubit j, wherein i∈(0, V] and j∈(0, P], then πᵢⱼ^{s}=True, otherwise πᵢⱼ^{s}=False.
A SWAP operand selection condition (cₖ^{s}): if edge k∈[0, K) is selected for performing SWAP gate number s, then cₖ^{s}=True, otherwise cₖ^{s}=False.

In some embodiments, encoding variables, such as those provided above, may be stored in SAT encoding definitions 170 (e.g., in gate scheduling condition(s) 172, qubit mapping condition(s) 174, SWAP operand selection condition(s) 176, etc.). A person having ordinary skill in the art should understand that additional encoding variables and/or conditions, such as the ones provided in the following paragraphs, may additionally be used to encode a quantum circuit mapping problem as a SAT solver problem, and may similarly be stored in SAT encoding definitions 170 (e.g., in other condition(s) 178).

The following paragraphs provide examples of additional constraints that may be used in a SAT solver formulation such as that which is described herein. Several of said constraints may additionally encode At-Most-One (AMO) conditions. A recursive scheme (e.g., a Heule encoding) may be leveraged as a generalized helper function for encoding AMO conditions in SAT solving constraints for the encoding of the quantum circuit mapping problem. To encode an AMO condition for a general set of Boolean variables B={b₀, . . . , bᵢ, . . . , bₙ₋₁}, the following recursive definition may be used (noting that y is an additional variable that does not occur in the rest of the definition):

$$AMO ( \{ {b}_{0} , … , {b}_{n - 1} \} ) = \{ \begin{matrix}{∧}_{i , j ∈ [ 0 , n ) , i < j} ( ¬ {b}_{i} ∨ ¬ {b}_{j} ) , & n \leq 4 \\ AMO ( \{ {b}_{0} , … , {b}_{2} , y ) ∧ AMO ( \{ {b}_{3} , … , {b}_{n - 1} , ¬ y \} ) , & n > 4\end{matrix}$$

A first example of a constraint in an SAT solver formulation that may be applied in a layout-transition-based order encoding scheme is a gate schedule initialization constraint, which may be defined as follows: for SWAP s∈[0,S) and gate gᵢ∈G, the SAT solver formulation is constrained such that it is not possible that gate gᵢ is scheduled both after SWAP gate number s and after SWAP gate number s+1. By de Morgan's law,

$$¬ ( {o}_{{g}_{i}}^{s} ∧ ¬ {o}_{{g}_{i}}^{s + 1} ) ⇔ ¬ {o}_{gi}^{s} ∨ {o}_{{g}_{i}}^{s + 1} for i ∈ [ 0 , n ) , and s ∈ [ 0 , S )$$

Also, all gates should be scheduled after SWAP gate number S, which may be defined as o_{g}_{ᵢ}^{s}=True for i∈[0, n).

A second example of a constraint in an SAT solver formulation that may be applied in a layout-transition-based order encoding scheme is a gate dependency constraint, which may be defined as follows: for (gᵢ, gⱼ)∈l_{g}, gate gⱼ cannot be scheduled before gate gᵢ (see also description with regard to FIG. 3A and initialization of a gate dependency list herein). This may be written as

$$¬ ( ¬ {o}_{{g}_{i}}^{s} ∧ {o}_{{g}_{j}}^{s} ) for i , j ∈ ( 0 , v ] , i < j , and s ∈ [ 0 , D ) ,$$

which, by de Morgan's law, may also be re-written as

$${o}_{{g}_{i}}^{s} ∨ ¬ {o}_{{g}_{j}}^{s} for i , j ∈ ( 0 , v ] i < j , and s ∈ [ 0 , D ) .$$

Continuing now with the first example constraint, referred to herein as the gate schedule initialization constraint, for all i∈[0, n) and s∈(1, D−1], if gate gᵢ is not scheduled after SWAP gate number s−1 and if gate gᵢ's gate operands are not mapped after SWAP gate number s, then gate gᵢ is constrained against being scheduled after SWAP gate number s. This may be written as

$$( ¬ {o}_{{g}_{i}}^{s - 1} ⋀ {∧}_{( j , l ) ∈ E} ( ¬ {π}_{{g}_{i} \cdot {op}_{m ax} j}^{s} ∨ ¬ {π}_{{g}_{i} \cdot {op}_{m i n} l}^{s} ) ∧ ( ¬ {π}_{{g}_{i} \cdot {op}_{m a x} l}^{s} ⋁ ¬ {π}_{{g}_{i} \cdot {op}_{m i n} j}^{s} ) ) \to ¬ {o}_{{g}_{i}}^{s} for i ∈ ( 0 , V ] ,$$

which may also be re-written as

$${o}_{{g}_{i}}^{s - 1} ∨ ¬ {o}_{{g}_{i}}^{s} ∨ {∨}_{( j , l ) ∈ E} ( {π}_{{g}_{i} \cdot {op}_{m a x} j}^{s} ∧ {π}_{{g}_{i} \cdot {op}_{m i n} l}^{s} ) ∨ ( {π}_{{g}_{i} \cdot {op}_{ma x} l}^{s} ∧ {π}_{{g}_{i} \cdot {op}_{m i n} j}^{s} ) .$$

Furthermore, if gate gᵢ is not scheduled after SWAP gate number s−1 and if gate gᵢ's gate operands are mapped after SWAP gate number s, then gate gᵢ is constrained to be scheduled after SWAP gate number s. This may be written as

$$( ¬ {o}_{{g}_{i}}^{s - 1} ∧ {∨}_{( k , l ) ∈ E} ( {π}_{{g}_{i} \cdot {op}_{m a x} j}^{s} ∨ {π}_{{g}_{i} \cdot {op}_{m i n} l}^{s} ) ∨ ( {π}_{{g}_{i} \cdot {op}_{m ax} l}^{s} ∨ {π}_{{g}_{i} \cdot {op}_{m i n} j}^{s} ) ) \to {o}_{{g}_{i}}^{s} for i ∈ ( 0 , V ] .$$

A third example of a constraint in an SAT solver formulation that may be applied in a layout-transition-based order encoding scheme is a unique SWAP selection constraint, which may be defined as follows: for each SWAP gate number s, only one physical edge k may be selected. This may be written as

$$AMO ( {\{ {c}_{i}^{s} \}}_{i = 0}^{K} ) for s ∈ [ 0. S ] .$$

A fourth example of a constraint in an SAT solver formulation that may be applied in a layout-transition-based order encoding scheme is a bijective layout mapping constraint, which may be defined as follows: the layout mapping condition πᵢⱼ^{s} introduced above is injective after each SWAP gate number s. This may be written as

$${∧}_{i ∈ V} AMO ( {\{ {π}_{ij}^{s} \}}_{j \neq 0}^{P} ) and {∧}_{j ∈ P} AMO ( {\{ {π}_{ij}^{s} \}}_{i = 0}^{V} ) for ∈ [ 0 , S ] .$$

A fifth example of a constraint in an SAT solver formulation that may be applied in a layout-transition-based order encoding scheme is a layout mapping update constraint, which may be defined as follows: after each SWAP gate number s, πᵢⱼ^{s-1} is updated to πᵢⱼ^{s}. If the particular SWAP gate number s is performed on the kth edge dₖ in E, wherein, without loss of generality, it may be assumed that dₖ stores edge eᵢⱼ, then the following sub-constraints explain the layout mapping update constraint:
If a logical qubit m is mapped to physical qubit i after SWAP gate number s−1 (e.g., πₘᵢ^{s-1}=True), then πₘⱼ^{s}=True. This may be written as

$$( {c}_{k}^{s} ∧ {π}_{m i}^{s - 1} ) \to {π}_{mj}^{s} for m ∈ ( 0 , V ] , k ∈ ( 0 , K ] ⇒ ¬ {c}_{k}^{s} ∨ {π}_{m i}^{s - 1} ∨ {π}_{mj}^{s} for m ∈ ( 0 , V ] , k ∈ ( 0 , K ] .$$

If a logical qubit m is mapped to physical qubit j after SWAP gate number s−1, then πₘᵢ^{s}=True. This may be written as

$$¬ {c}_{k}^{s} ∨ ¬ {π}_{mj}^{s - 1} ∨ {π}_{m i}^{s} for m ∈ ( 0 , V ] , k ∈ ( 0 , K ] .$$

If a logical qubit m is mapped to i,j, then the qubit mapping after SWAP gate number s−1 and after SWAP gate number s are the same. This may be written as

$$¬ {c}_{k}^{s} ∨ ¬ {π}_{m l}^{s - 1} ∨ {π}_{m l}^{s} for m , l ∈ ( 0 , V ] , k ∈ ( 0 , K ] .$$

A sixth example of a constraint in an SAT solver formulation that may be applied is a time-out constraint. Time-out information may be added to a request to solve for a quantum circuit mapping problem wherein the time-out information comprises instructions to terminate said request (e.g., if a solution is not found within a given amount of time, if there are not enough computing resources currently allocated to solve the quantum circuit mapping problem in a reasonable amount of time, etc.). Furthermore, a customer may submit a request that includes multiple quantities of SWAP gates that they request that the SAT solver attempt to solve for, such as the 3, 4, and 5 SWAP gates determination attempts shown in field 208 of FIG. 2, and said three attempts may be run in parallel using multiple compute instances configured to perform SAT solving. In such embodiments, the customer may include time-out information that specifies that, if a “satisfiable” result is returned by one of the compute instances for an assignment using N SWAP gates before other compute instance(s) return any result (“satisfiable” or “unsatisfiable”) for SWAP gate determination attempts using greater than N SWAP gates, the compute instance(s) associated to the greater than N SWAP gate determination attempt(s) may terminate those particular requests, for example. Such embodiments may occur if a customer is trying to determine a minimal number of SWAP gates required to produce a quantum circuit mapping. In a second example, a customer may include time-out information that specifies that, if an “unsatisfiable” result is returned by a compute instance for an attempted assignment using N SWAP gates before any other compute instances return any attempts using SWAP gate numbers less than N SWAP gates, the compute instance(s) associated to the less than N SWAP gate determination attempt(s) may terminate those particular requests.

The constraints discussed herein may be used to define a CNF equation representing a given quantum circuit mapping problem that is then provided to a SAT solver (see also description pertaining to block 818 herein). As related to the discussion herein, a SAT solver may be defined as an optimization problem solver that takes binary (e.g., True/False, zero or one, etc.) inputs and solves binary constraints, such as the constraint examples described above. By encoding a particular quantum circuit mapping problem using a binary formalism (e.g., a CNF equation), the encoded quantum circuit mapping may then be provided to a SAT solver, which, in turn, returns solutions (if at least one exists) to each of the SAT encoding variables defined in the CNF equation.

A person having ordinary skill in the art should understand that the above SAT encoding definitions and constraints on the SAT solving formulation define boundaries for a bounded problem being solved by an SAT solver. In some embodiments, given a particular quantum circuit mapping problem, a SAT solver may return a “satisfiable” result (see also description pertaining to FIG. 5B herein) if at least one solution exists such that the assignment is True under the specified bounded conditions/constraints. Otherwise, a SAT solver may return an “unsatisfiable” result, meaning that no assignment could be found under the specified bounded conditions/constraints.

FIG. 5A illustrates an example of a mapping of the logical quantum circuit shown in FIG. 3B to a quantum hardware device that has the physical qubit connectivity graph shown in FIG. 3A, wherein the mapping has been resolved using 5 SWAP gates, according to some embodiments.

In some embodiments, FIG. 5A may represent a solution (e.g., quantum circuit mapping result 520) to a quantum circuit mapping of logical quantum circuit 320 to physical qubit connectivity graph 300 using exactly 5 SWAP gates. Quantum circuit mapping result 520 may have been generated by encoding the given quantum circuit mapping problem into a SAT solver problem and submitting the encoded problem (e.g., the CNF equation representing the encoded quantum circuit mapping problem) to the SAT solver, according to some embodiments.

Quantum circuit mapping result 520 considers an initial (first) logical [symbol] physical qubit mapping of {A [symbol] q₃₀₁, B [symbol] q₃₀₂, C [symbol] q₃₀₃, D [symbol] q₃₀₄} which may be used to schedule performance of gate g₀ prior to the first out of five SWAP gates. Following the scheduling of gate g₀, the first SWAP gate (e.g., wherein a SWAP gate comprises three CNOT gates as shown in FIG. 5A) is scheduled between logical qubits B and D such that the logical [symbol] physical qubit mapping is then updated to {A [symbol] q₃₀₁, D [symbol] q₃₀₂, C [symbol] q₃₀₃, B [symbol] q₃₀₄}. This allows gate g₁ to be scheduled via the updated (second) logical-physical qubit mapping. A reflection of this updated logical [symbol] physical qubit mapping is represented in logical interpretation of intermediate mappings 500. However, a person having ordinary skill in the art should understand that logical interpretation of intermediate mappings 500 is meant to convey a visual representation of the logical [symbol] physical qubit mapping as said mapping changes throughout performance of quantum circuit mapping result 520 and is meant to aid the reader in understanding FIG. 5A. It does not represent any physical change to physical qubit connectivity graph 300.

This first SWAP gate and updated intermediate logical [symbol] physical qubit mapping also marks the first layout transition step (e.g., timestep 1), as explained above with regard to format for the layout-transition-based order encoding 400.

As shown in FIG. 5A, following the scheduling of gate g₁, a SWAP gate is scheduled between logical qubits D and C such that the logical [symbol] physical qubit mapping is again updated (for a third time) to {A [symbol] q₃₀₁, C [symbol] q₃₀₂, D [symbol] q₃₀₃, B [symbol] q₃₀₄}. This allows gate g₂ to be scheduled via the updated (second) logical [symbol] physical qubit mapping. Such a process of scheduling one or more gates, followed by another SWAP gate to update the logical [symbol] physical qubit mapping, etc., continues until five total SWAP gates have been implemented and all gates (e.g., gates g₀ through g₅) are scheduled.

FIG. 5B illustrates an example of a part of a result of a SAT solver for a mapping of the logical quantum circuit shown in FIG. 3B to a quantum hardware device that has the physical qubit connectivity graph shown in FIG. 3A, wherein the mapping has been resolved using 5 SWAP gates and the mapping has been encoded using a layout-transition-based order encoding scheme, according to some embodiments.

In general, a SAT solver may return one of the following results: (1) a “satisfiable” or “sat” result, which may be interpreted as a SAT solver finding a solution to the requested SAT solver problem; or (2) an “unsatisfiable” or “unsat” result, which may be interpreted as a SAT solver finding no solution to the requested SAT solver problem. In some embodiments, a SAT solver may also time-out and/or return no result (e.g., due to computing restraints where the SAT solver is located, due to a time-out constraint in a quantum circuit mapping request in which a customer may request to terminate the solving attempt after a certain amount of time if no solution is found, etc.). In some embodiments as described herein, a “sat” result may be interpreted as a SAT solver finding at least one assignment for the given encoded quantum circuit mapping problem using the requested number of SWAP gates, and an “unsat” result may be interpreted as a SAT solver finding no assignment for the given encoded quantum circuit mapping problem using the requested number of SWAP gates.

In some embodiments such as that which is shown in FIG. 5B, a SAT solver may return a “satisfiable” result to the encoded quantum circuit mapping problem of mapping logical quantum circuit 320 to physical qubit connectivity graph 300 using exactly 5 SWAP gates. A SAT solver may additionally provide a results matrix (e.g., SAT solver solution 540), such as that which is shown in FIG. 5B, wherein each of gates g₀ through g₅ have been successfully scheduled using 5 SWAP gates. A SAT solver may further provide a mapping associated with a given results matrix (e.g., quantum circuit mapping result 520 associated with SAT solver solution 540). In some embodiments, a SAT solver may return one, several, or all assignments of a total number of assignments that are possible for a given quantum circuit mapping problem using a given number of SWAP gates. Furthermore, a SAT solver may return multiple assignments of the total number of assignments at a same moment in time or sequentially. A customer may request via interface 200 an intention to receive one, several, or all assignments that a SAT solver may find for a given quantum circuit mapping problem, given that there is at least one “satisfiable” solution to the given problem.

A matrix solution such as SAT solver solution 540 may have additional benefits. For example, a customer receiving SAT solver solution 540 in response to requesting a given quantum circuit mapping may quickly look at SAT solver solution 540 and understand that gate g₀ has been scheduled prior to timestep 1, that both gates g₀ and g₁ have been scheduled prior to timestep 2, that gate g₅ has been scheduled after timestep 5, etc. Furthermore, a customer may only need to look at the bit (e.g., True/False) in a given row of the matrix in SAT solver solution 540 to know if a particular gate has been successfully scheduled or not using the targeted number of SWAP gates to solve the given encoded quantum circuit mapping problem. For example, a customer may only need to look at the last column of SAT solver solution 540 wherein gates g₀ through g₅ have values of “True” to know that all gates have successfully been scheduling and that the SAT solver has determined at least one assignment for the given quantum circuit mapping problem.

FIGS. 6 and 7 illustrate examples of mappings of the logical quantum circuit shown in FIG. 3B to a quantum hardware device that has the physical qubit connectivity graph shown in FIG. 3A, wherein the mappings have been resolved using 4 SWAP gates and 3 SWAP gates, respectively, according to some embodiments.

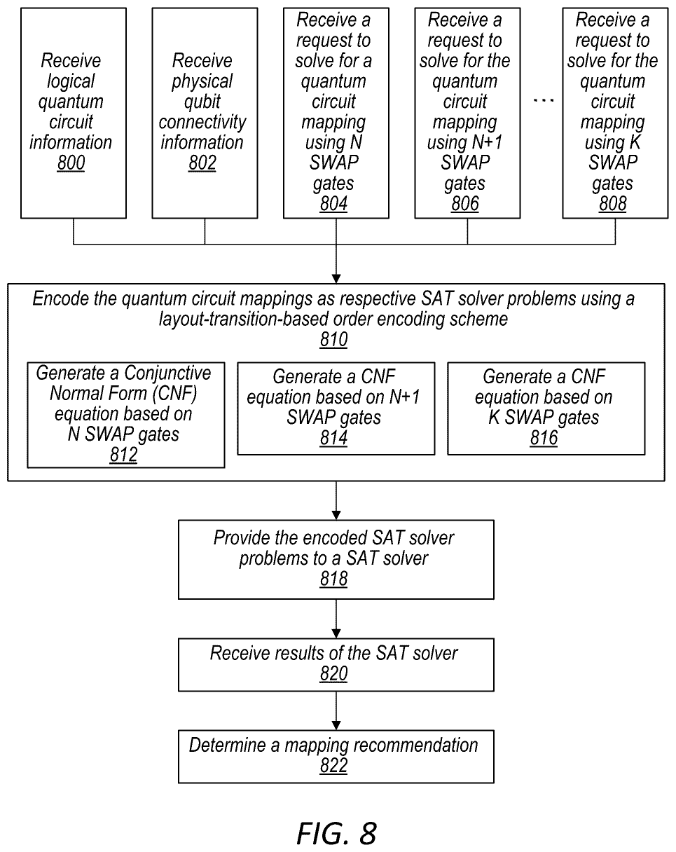

Quantum circuit mapping result 620 illustrates one quantum circuit mapping solution that uses exactly four SWAP gates. A person having ordinary skill in the art should understand that quantum circuit mapping result 620 represents one solution that uses exactly four SWAP gates given the encoded quantum circuit mapping problem, and that additional solutions that use exactly four SWAP gates may also be solved for by the SAT solver. In some embodiments, a SAT solver may return all possible quantum circuit mapping solutions that use exactly four SWAP gates, including quantum circuit mapping result 620. In other embodiments, a SAT solver may simply return “satisfiable” to indicate that there are possible quantum circuit mapping solutions that may be generated using exactly four SWAP gates. Such information from the SAT solver may be used to determine a mapping recommendation for a customer (e.g., as described in block 814 in FIG. 8).

Quantum circuit mapping result 720 illustrates one quantum circuit mapping solution that uses exactly three SWAP gates.

Corresponding SAT solver solutions matrices for FIGS. 6 and 7 may also be generated based, at least in part, on the outline provided in format 400, as is shown via SAT solver solution 540 for the corresponding quantum circuit mapping result 520 in FIG. 5B. As described above, a layout-transition-based order encoding scheme may significantly reduce a size of a matrix with respect to other optimization problem solving techniques. For example, a SAT solver solution matrix corresponding to quantum circuit mapping result 620 may resemble the following:

$$( \begin{matrix}{g}_{0} \\ {g}_{1} \\ {g}_{2} \\ {g}_{3} \\ {g}_{4} \\ {g}_{5}\end{matrix} ) = ( \begin{matrix}True \\ False \\ False \\ False \\ False \\ False\end{matrix} \vert \begin{matrix}True \\ True \\ True \\ False \\ False \\ False\end{matrix} \vert \begin{matrix}True \\ True \\ True \\ True \\ False \\ False\end{matrix} \vert \begin{matrix}True \\ True \\ True \\ True \\ True \\ False\end{matrix} \vert \begin{matrix}True \\ True \\ True \\ True \\ True \\ True\end{matrix} ) .$$

There are five columns respectively separated by four timesteps, corresponding to four SWAP gate based logical [symbol] physical qubit mapping transitions. As seen in the above matrix representation, gates g₁ and g₂ are both scheduled after timestep 1 and before timestep 2, and may be represented in the same column two (reading left to right) of the matrix. It may be noted, therefore, that whether one gate, two gates, etc., are scheduled in between two given timesteps, this may still be represented within a same column of the matrix. This example demonstrates a compact nature with which a layout-transition-based order encoding scheme allows one to configure a SAT solver problem which, in turn, may reduce an amount of time that a given SAT solver requires to solve for a given quantum circuit mapping with respect to other optimization problem solving techniques.

FIG. 8 is a flowchart illustrating a process of generating a quantum circuit mapping (e.g., to be used for executing a quantum circuit using a given quantum hardware device) by encoding the quantum circuit mapping as a SAT solver problem, according to some embodiments.

In block 800, a customer of a compilation service such as compilation service 134 within service provider network 100 may provide information pertaining to a logical quantum circuit. As discussed above, logical quantum circuit information may include a variety of inputs that a compilation service may be configured to receive and use to prepare a CNF equation according to a layout-transition-based order encoding scheme such as that which is discussed herein. For example, logical quantum circuit information may include a gate dependency list, and/or a gates list and a logical qubits list, and/or a logical quantum circuit, examples of which are shown in FIG. 3B. In some embodiments in which a compilation service is provided with a logical quantum circuit, such as logical quantum circuit 320, the compilation service may be configured to generate a gate dependency list from information provided in the logical quantum circuit. Such a gate dependency list may then be used, at least in part, to generate the CNF equation.

In block 802, a customer of a compilation service may provide information pertaining to the physical qubit connectivity of a given quantum hardware device. Also as discussed above, physical qubit connectivity information may include a variety of inputs that a compilation service may be configured to receive and also use to prepare the CNF equation. For example, physical qubit connectivity information may include a physical qubits list and an edges list, and/or a physical qubit connectivity graph, examples of which are shown in FIG. 3A. In some embodiments in which a compilation service is provided with a physical qubit connectivity graph, such as physical qubit connectivity graph 300, the compilation service may be configured to generate a physical qubits list and an edges list from information provided in the physical qubit connectivity graph. Such a gate dependency list may then be used, at least in part, to generate the CNF equation. In some embodiments, physical qubit connectivity information may include an indication of a particular quantum hardware provider, a particular quantum hardware device located at said quantum hardware provider, and/or qubit technology that a customer would like to use to execute a logical quantum circuit. In such embodiments, a compilation service of a service provider network may be configured to communicate with one or more other services of the service provider network, such as a quantum computing service, in order to obtain information (e.g., a physical qubits list and an edges list, and/or a physical qubit connectivity graph) about said quantum hardware provider, as shown in FIG. 1A herein.

In some embodiments, a customer of a compilation service may additionally provide an indication of a number of SWAP gates that a quantum circuit mapping problem is to be solved using. As shown in block 804, a request to solve for a quantum circuit mapping using N SWAP gates is provided to the compilation service. In some embodiments, more than one quantity of SWAP gates may be requested, as shown in blocks 804, 806, and 808 in which requests for solving for a given quantum circuit mapping using N. N+1, and K SWAP gates are provided. In some embodiments, requests using N. N+1, and K SWAP gates may be provided as one request (e.g., a request that includes information as shown in blocks 800, 802, 804, 806, and 808) or multiple requests (e.g., a request that includes information shown in blocks 800, 802, and 804; a second request that includes information shown in blocks 800, 802, and 806, etc.). Furthermore, requested numbers of SWAP gates provided in blocks 804, 806, and 808 may or may not be consecutive. In alternative embodiments, blocks 804-808 may be formulated as a request to solve a given quantum circuit mapping problem using a maximum number of SWAP gates K, and compilation service 134 may pre-process this information to generate sub-requests to solve using N. N+1, . . . , and K SWAP gates, respectively.

The above paragraphs discuss embodiments in which a customer is providing information to a compilation service as part of a request to generate a quantum circuit mapping. In some embodiments, such information may be provided and/or partially provided by one or more other services of the service provider network, such as in embodiments in which a request to generate a quantum circuit mapping is part of a larger request to execute a quantum algorithm using a given quantum hardware device of a quantum hardware provider accessible via the service provider network, and therefore a quantum computing service may communicate with a compilation service in order to provide information such as that which is described in blocks 800-808.

In block 810, information provided in blocks 800, 802, 804, 806, and 808 may be used to encode a quantum circuit mapping problem into a SAT solver problem using a layout-transition-based order encoding scheme, such as that which is described herein. In some embodiments, the encoded quantum circuit mapping problem(s) may be translated into one or more CNF equations, as shown in blocks 812, 814, and 816, which conform to SAT solving formulism and therefore may be provided to a SAT solver.

In block 818, the encoded SAT solver problem(s) are provided to a SAT solver. In some embodiments wherein two or more CNF equations have been generated (e.g., blocks 812, 814, and 816), the encoded SAT solver problems may be solved for in parallel, as their outcomes are independent from one another from a SAT solver's perspective. In some embodiments, this may be accomplished through a cloud computing configuration in which multiple SAT solving instances may be accessed by the compilation service.

In block 820, results of the SAT solving attempts are provided to the compilation service. In some embodiments, results may comprise a “satisfiable” result which may be interpreted as a SAT solver having successfully found at least one assignment wherein the given constraints of the CNF equation are True. In some embodiments, results may comprise an “unsatisfiable” result which may be interpreted as a SAT solver having not found a minimum of one assignment wherein the given constraints of the CNF equation are True. In some embodiments in which multiple CNF equations have been provided to respective SAT solving instances, results may be provided simultaneously or not.

In block 822, a mapping recommendation may be determined and/or provided to the customer that made the quantum circuit mapping request. In some embodiments, the following examples of mapping recommendations may be viewed as “post-processing” steps. For example, if one or more of the requests returned a “satisfiable” solution, a mapping recommendation may include an indication that the given quantum circuit mapping problem may indeed be mapped using the given requested number of SWAP gates, according to some embodiments. In another example, if one or more of the requests returned an “unsatisfiable” result, a mapping recommendation may include an indication that the given quantum circuit mapping problem may not be mapped using the given requested number of SWAP gates. The mapping recommendation may also include a recommendation of other quantities of SWAP gates to attempt to solve for in a follow-up request, a recommendation of a different qubit technology to try, etc., upon receiving an “unsatisfiable” result. As discussed above with regard to FIG. 4, a request may additionally include time-out information. In such embodiments, results in block 820 may also include an indication that a given SAT solving instance timed out, and a mapping recommendation in block 822 may then include a recommendation for increasing computing resources if a customer would like to attempt that specific combination again, etc.

In addition, a mapping recommendation in block 822 may include information pertaining to a SAT solver finding an optimal number of SWAP gates that may be used for a given quantum circuit mapping problem. For example, if a first encoded SAT solver problem using N SWAP gates returns an “unsatisfiable” result and a second encoded SAT solver problem using N+1 SWAP gates returns a “satisfiable” solution, compilation service 134 and/or optimization problem service 142/144 may determine that a minimum number of SWAP gates required to generate at least one assignment wherein all constraints of the encoded SAT solver problem are True is N+1 SWAP gates. In such embodiments, a quantum compilation service applying SAT solving may be used to find a minimum number of SWAP gates required for a given quantum circuit mapping problem.

Furthermore, received results of block 820 may comprise more than one “satisfiable” solution to a given quantum circuit mapping problem, wherein the more than one solutions correspond to respective mappings that each satisfy the given constraints of the quantum circuit mapping problem, and a mapping recommendation in block 822 may therefore include a determination of a suggested and/or preferred mapping of the total number of received mappings. For example, compilation service 134 may have noise profiles, corresponding to different quantum hardware devices, which may be stored in physical qubit connectivity information 160, and compilation service 134 may use such stored noise profiles to analyze the received mappings against a noise profile to determine a potential for increased error due to certain physical qubits being used more frequently than other physical qubits during a given mapping result, etc. In such embodiments, a mapping recommendation may include an indication to avoid one or more mappings of the total mappings that compilation service 134 determines may produce more error during a future execution, and/or may include an indication that identifies one or more preferred mappings of the total mappings that compilation service 134 determines may produce less error during a future execution with respect to one or more of the other mappings of the total mappings.

The above examples pertaining to determining mapping recommendations may be viewed as “post-processing” steps completed by compilation service 134, and in embodiments in which one or more of such post-processing steps are performed using the received results of the SAT solver, this may globally be referred to as generating a quantum circuit mapping for a customer. Such a generation may therefore encompass any additional formatting done to the received results, any selection of one or more received results from a total, any summarization of the received results into layman's terms intended for a person not having ordinary skill in the art, etc.

FIG. 9 illustrates edge computing devices of a quantum computing service physically located at quantum hardware provider locations, according to some embodiments.

In some embodiments, service provider network 100, as illustrated in FIG. 1A, may include one or more data centers connected to each other via private or public network connections. Also, edge computing devices located at quantum hardware provider locations may be connected to a service provider network via private or public network connections. For example, service provider network 100 illustrated in FIG. 9 includes data centers 906a, 906b, and 906c that are connected to one another via private physical network links of the service provider network 100. In some embodiments, a customer of the service provider network may also be connected via a private physical network link that is not available to the public to carry network traffic, such as a physical connection at a router co-location facility. For example, customer 910 is connected to a router associated with data center 906c via direct connection 924. In a similar manner, edge computing devices located at quantum hardware provider locations may be connected to a service provider network via a private physical network link that is not available to carry public network traffic.

For example, edge computing device 904a located at quantum hardware provider location 902a is connected to a router at data center 906a via direct connection 918. In a similar manner, edge computing device 904b at quantum hardware provider location 902b is connected to a router at data center 906b via direct connection 920. Also, edge computing device 904c at quantum hardware provider 902c is connected to a router at data center 906c via direct connection 922.

Also, in some embodiments an edge computing device of a service provider network located at a quantum hardware provider location may be connected to the service provider network via a logically isolated network connection over a shared network connection, such as via the Internet or another public network. For example, edge computing device 904d at quantum hardware provider location 902d is connected to data center 906c via a logically isolated network connection via network 916. In a similar manner, in some embodiments a customer, such as customer 914, may be connected to service provider network 100 via public network 912.

In some embodiments, similar configurations may exist between compilation service 134 and optimization problem service 142. For example, compilation service 134 may be connected to optimization problem service 142 by using a logically isolated network connection via a public network, or by using a dedicated physical non-public network link. In some embodiments, another edge computing device may be placed at a premises of optimization problem service 142 such that compilation service 134 may be connected to optimization problem service 142 via an edge computing device.

In some embodiments, a quantum computing service such as quantum computing service 102, may be implemented using one or more computing devices in any of data centers 906a, 906b, 906c, etc. Also, quantum computing service 102 may provide customers, such as customer 914 or customer 910, access to quantum computers in any of quantum hardware provider locations 902a, 902b, 902c, 902d, etc. For example, a customer may not be restricted to using a quantum hardware provider in a local region where the customer is located. Instead, the customer may be allocated compute instances instantiated on a local edge computing device located at a selected quantum hardware provider location, such that the location of the customer does not restrict the customer's access to various types of quantum computing technology-based quantum computers.

In some embodiments, one or more of the data centers 906 may also include local quantum hardware devices, such as local QPUs 926. One or more of data centers 906 may also include a local optimization problem service, such as optimization problem service 144 in which one or more computing devices at data centers 906 are configured to perform various optimization solving techniques such as SAT solving (e.g., SAT solver 146).

### Example Edge Computing Device Located at a Quantum Hardware Provider Location

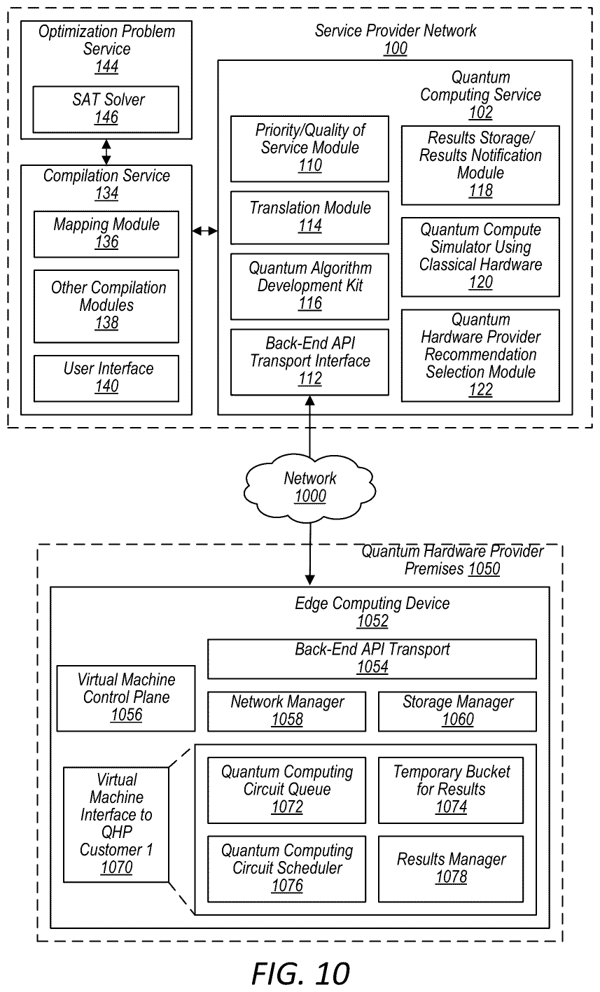

FIG. 10 illustrates an example edge computing device connected to a quantum computing service, according to some embodiments.

Service provider network 100 and quantum computing service 102 may be similar to the service provider networks and quantum computing services described herein, such as in FIG. 1A. Also, edge computing device 1052 may be a similar edge computing device as any of the edge computing devices described previously, such as in FIG. 1A or 9. Edge computing device 1052 may be connected to service provider network 100 via network connection 1000, which may be a logically isolated network connection via a public network, a dedicated physical non-public network link, or other suitable network connection.

Edge computing device 1052 may include network manager 1058, storage manager 1060, and virtual machine control plane 1056.

In some embodiments, a back-end application programmatic interface (API) transport of an edge computing device, such as back-end API transport 1054 of edge computing device 1052 may ping a quantum computing service to determine if there are one or more quantum tasks (e.g., quantum circuits) waiting to be transported to the edge computing device. The edge computing device may further use a non-public back-end API transport, such as back-end API transport 1054 to bring the quantum circuit into the edge computing device 1052.

Additionally, for each customer, a back-end API transport of an edge computing device of a quantum computing service, such as back-end API transport 1054 of edge computing device 1052, may cause a virtual machine to be instantiated to manage scheduling and results for a given quantum circuit pulled into the edge computing device from a back-end API. For example, virtual machine 1070 may act as an interface to the quantum hardware provider for a given customer (e.g., customer 1) of the service provider network. The edge computing device may be directly connected to a local non-public network at the quantum hardware provider location and may interface with a scheduling component of the quantum hardware provider to schedule availability (e.g., usage slots) on a quantum computer of the quantum hardware provider.

In some embodiments, the virtual machine 1070 may be booted with a particular quantum machine image that supports interfacing with the scheduling component of the quantum hardware provider, wherein different quantum hardware providers require different scheduling interfaces.

In some embodiments, virtual machine 1070 may be booted with a quantum circuit queuing component 1072, a quantum circuit scheduling component 1076, a component that manages a local storage bucket on the edge computing device to temporarily store results, such as temporary bucket 1074 and results manager 1078. In some embodiments, quantum circuit scheduling component 1076 may order quantum circuits in quantum circuit queuing component in the order they are received, wherein the received order enforces quality of service (QOS) guarantees by ordering the quantum tasks in the quantum task queue of the quantum computing service based on priorities determined using the QoS guarantees.

In some embodiments, an edge computing device, such as edge computing device 1052, may support multi-tenancy (e.g., service multiple customers of service provider network 100). Also, in some embodiments, edge computing device 1052 may also instantiate virtual machines that execute classical computing tasks, such as a classical computing portion of a hybrid algorithm. For example, virtual machine 1070 may be further configured to perform classical compute portions of a hybrid algorithm.

In some embodiments, a back-end API transport of an edge computing device located a quantum hardware provider location may interface with a back-end API transport interface 112 of a computing device/router at a remote location where one or more computing devices that implement the quantum computing service are located.

Note that edge computing device 1052 may be physically located (e.g., co-located) at quantum hardware provider premises 1050, such as in a building of a quantum hardware provider facility.

In some embodiments, the components of virtual machine 1070 may be included in back-end API transport 1054, and the back-end API transport 1054 may execute the related components within the back-end API transport without causing a separate VM 1070 to be instantiated.

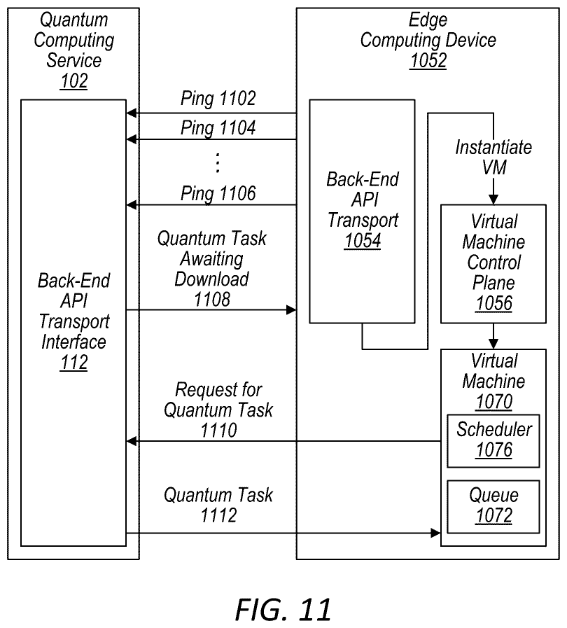

FIG. 11 illustrates example interactions between a quantum computing service and an edge computing device of the quantum computing service, according to some embodiments.

A back-end API transport 1054 of edge computing device 1052 may submit pings 1102, 1104, 1106, etc. to quantum computing service 102 to determine whether there is a quantum task (e.g., a quantum circuit) to be transported to edge computing device 1052. At 1108, the quantum computing service 102 may indicate to the edge computing device 1052 that there is a translated quantum circuit (e.g., a logical quantum circuit, such as logical quantum circuit 320, that has been mapped to a given quantum hardware device of a given quantum hardware provider and translated into a format acceptable by the quantum hardware provider) ready to be transported to the edge computing device 1052. In response, back-end API transport 1054 may cause virtual machine control plane 1056 to instantiate a virtual machine 1070 to act as an interface for the customer to the quantum hardware provider. At 1110 the VM 1070 may call the back-end API transport 1054 requesting the translated quantum circuit (e.g., quantum task or batch of quantum tasks). In response, at 1112, the back-end API transport 1054 may cause the translated quantum circuit (e.g., quantum task or batch of quantum tasks) to be transported to the queue 1072 of VM 1070. In some embodiments, instead of pings of a polling protocol, an edge computing device 1052 may use various other techniques to determine whether there is a quantum computing circuit (e.g., quantum task or batch of quantum tasks) ready to be transported to edge computing device 1052. Also, in some embodiments, a given quantum hardware provider may include more than one quantum computer and/or types of quantum computers. In such embodiments, a back-end API transport and/or VM interface to the quantum hardware provider may route a quantum circuit that is to be executed at the quantum hardware provider to an assigned quantum computer at the quantum hardware provider.

In some embodiments, quantum tasks may come over to queue 1072 with associated access tokens and the quantum tasks may be ordered in queue 1072 based on their respective access tokens, or time stamps included in the respective access tokens.

### Illustrative Computer System

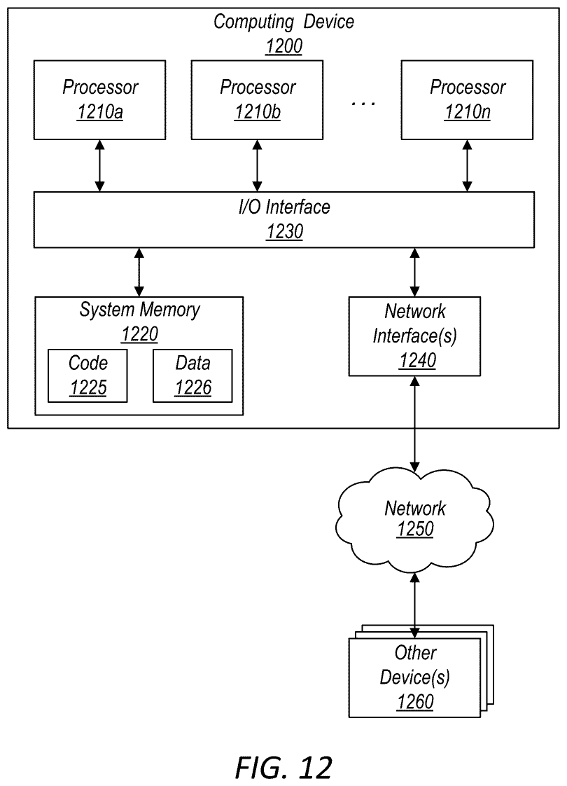

FIG. 12 is a block diagram illustrating an example computing device that may be used in at least some embodiments.

FIG. 12 illustrates such a general-purpose computing device 1200 as may be used in any of the embodiments described herein. In the illustrated embodiment, computing device 1200 includes one or more processors 1210 coupled to a system memory 1220 (which may comprise both non-volatile and volatile memory modules) via an input/output (I/O) interface 1230. Computing device 1200 further includes a network interface 1240 coupled to I/O interface 1230.

In various embodiments, computing device 1200 may be a uniprocessor system including one processor 1210, or a multiprocessor system including several processors 1210 (e.g., two, four, eight, or another suitable number). Processors 1210 may be any suitable processors capable of executing instructions. For example, in various embodiments, processors 1210 may be general-purpose or embedded processors implementing any of a variety of instruction set architectures (ISAs), such as the x86, PowerPC, SPARC, or MIPS ISAs, or any other suitable ISA. In multiprocessor systems, each of processors 1210 may commonly, but not necessarily, implement the same ISA. In some implementations, graphics processing units (GPUs) may be used instead of, or in addition to, conventional processors.

System memory 1220 may be configured to store instructions and data accessible by processor(s) 1210. In at least some embodiments, the system memory 1220 may comprise both volatile and non-volatile portions; in other embodiments, only volatile memory may be used. In various embodiments, the volatile portion of system memory 1220 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1220 as code 1225 and data 1226.

In some embodiments, I/O interface 1230 may be configured to coordinate I/O traffic between processor 1210, system memory 1220, and any peripheral devices in the device, including network interface 1240 or other peripheral interfaces such as various types of persistent and/or volatile storage devices. In some embodiments, I/O interface 1230 may perform any necessary protocol, timing or other data transformations to convert data signals from one component (e.g., system memory 1220) into a format suitable for use by another component (e.g., processor 1210). In some embodiments, I/O interface 1230 may include support for devices attached through various types of peripheral buses, such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. Also, in some embodiments some or all of the functionality of I/O interface 1230, such as an interface to system memory 1220, may be incorporated directly into processor 1210.

Network interface 1240 may be configured to allow data to be exchanged between computing device 1200 and other devices 1260 attached to a network or networks 1250, such as other computer systems or devices as illustrated in FIG. 1A through FIG. 11, for example. In various embodiments, network interface 1240 may support communication via any suitable wired or wireless general data networks, such as types of Ethernet network, for example. Additionally, network interface 1240 may support communication via telecommunications/telephony networks such as analog voice networks or digital fiber communications networks, via storage area networks such as Fibre Channel SANs, or via any other suitable type of network and/or protocol.

In some embodiments, system memory 1220 may represent one embodiment of a computer-accessible medium configured to store at least a subset of program instructions and data used for implementing the methods and apparatus discussed in the context of FIG. 1A through FIG. 11. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1200 via I/O interface 1230. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1200 as system memory 1220 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1240. Portions or all of multiple computing devices such as that illustrated in FIG. 12 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
one or more computing devices of a service provider network configured to implement a quantum computing service, wherein the quantum computing service is configured to enable execution of quantum circuits using a plurality of quantum hardware devices; and
one or more computing devices of the service provider network configured to implement a quantum compilation service configured to map a logical quantum circuit for execution using a given one of the quantum hardware devices, wherein to implement the quantum compilation service, the one or more computing devices are further configured to:
receive a request to generate a quantum circuit mapping, wherein the request comprises:
logical quantum circuit information corresponding to the logical quantum circuit;
physical qubit connectivity information corresponding to the given quantum hardware device; and
a number of SWAP gates to be used in the quantum circuit mapping;
encode the quantum circuit mapping as a SAT solver problem, wherein to encode the quantum circuit mapping, the one or more computing devices are further configured to generate a Conjunctive Normal Form (CNF) equation that represents the quantum circuit mapping based, at least in part, on:
a layout-transition-based order encoding scheme; and
the request;
provide the encoded SAT solver problem to a SAT solver; and
responsive to receiving results of the SAT solver, generate the quantum circuit mapping, wherein the quantum circuit mapping is generated based, at least in part, on the number of SWAP gates indicated in the request; and
provide the quantum circuit mapping to the quantum computing service,
wherein the one or more computing devices that implement the quantum computing service are further configured to submit the quantum circuit mapping for use in execution of the logical quantum circuit using the given quantum hardware device.

2. The system of claim 1, further comprising one or more computing devices of the service provider network configured to implement an optimization problem service, wherein:
to implement the optimization problem service, the one or more computing devices are further configured to implement the SAT solver; and
the one or more computing devices of the service provider network configured to implement the quantum compilation service are further configured to provide the encoded SAT solver problem to the SAT solver via the optimization problem service.

3. The system of claim 1 wherein the one or more computing devices of the service provider network configured to implement the quantum compilation service are further configured to:
encode one or more alternative quantum circuit mappings as one or more alternative SAT solver problems, wherein to encode the one or more alternative quantum circuit mappings, the one or more computing devices of the service provider network configured to implement the quantum compilation service are further configured to generate one or more alternative CNF equations that represent the respective one or more alternative quantum circuit mappings based, at least in part, on:
the logical quantum circuit information;
the physical qubit connectivity information; and one or more alternative quantities of SWAP gates indicated in the request or in one or more additional requests; and
provide the one or more encoded alternative SAT solver problems to the SAT solver in parallel with the encoded SAT solver problem.

4. The system of claim 1, wherein:
the logical quantum circuit information comprises a logical quantum circuit; and
the one or more computing devices of the service provider network configured to implement the quantum compilation service are further configured to determine, based, at least in part, on the logical quantum circuit, a list of logical qubits and a list of gates to be performed on respective ones of the logical qubits, wherein the list of gates is ordered in terms of one or more dependencies of outcomes of respective gates, performed on respective logical qubits of the list of logical qubits, on other respective gates, performed on the respective logical qubits.

5. The system of claim 1, wherein the service provider network is configured to:
provide an interface to accept inputs of the request; and
provide the inputs of the request to the quantum compilation service.

6. A system, comprising:
one or more computing devices of a service provider network configured to implement a quantum compilation service configured to map a logical quantum circuit for execution using a quantum hardware device, wherein to implement the quantum compilation service, the one or more computing devices are further configured to:
receive a request to generate a quantum circuit mapping, wherein the request comprises:
logical quantum circuit information corresponding to the logical quantum circuit;
physical qubit connectivity information corresponding to the quantum hardware device; and
a number of SWAP gates to be used in the quantum circuit mapping;
encode the quantum circuit mapping as a SAT solver problem, wherein to encode the quantum circuit mapping, the one or more computing devices are further configured to generate a Conjunctive Normal Form (CNF) equation that represents the quantum circuit mapping based, at least in part, on:
a layout-transition-based order encoding scheme; and
the request;
provide the encoded SAT solver problem to a SAT solver;
receive results of the SAT solver;
determine a mapping recommendation based, at least in part, on the results of the SAT solver; and
provide the mapping recommendation.

7. The system of claim 6, wherein the one or more computing devices are further configured to coordinate execution of the encoded SAT solver problem on one or more computing devices configured to perform SAT solving.

8. The system of claim 6, wherein the one or more computing devices are further configured to:
encode one or more alternative quantum circuit mappings as one or more alternative SAT solver problems, wherein to encode the one or more alternative quantum circuit mappings, the one or more computing devices are further configured to generate one or more alternative CNF equations that represent the respective one or more alternative quantum circuit mappings based, at least in part, on:
the logical quantum circuit information;
the physical qubit connectivity information; and
one or more alternative quantities of SWAP gates indicated in the request or in one or more additional requests; and
provide the one or more encoded alternative SAT solver problems to the SAT solver in parallel with the encoded SAT solver problem.

9. The system of claim 6, wherein the logical quantum circuit information comprises:
a list of logical qubits; and
a list of gates to be performed on respective ones of the logical qubits, wherein the list of gates is ordered in terms of one or more dependencies of outcomes of respective gates performed on respective logical qubits of the list of logical qubits on other respective gates performed on the respective logical qubits.

10. The system of claim 6, wherein:
the logical quantum circuit information comprises a logical quantum circuit; and
the one or more computing devices are further configured to determine, based, at least in part, on the logical quantum circuit, a list of logical qubits and a list of gates to be performed on respective ones of the logical qubits, wherein the list of gates is ordered in terms of one or more dependencies of outcomes of respective gates performed on respective logical qubits of the list of logical qubits on other respective gates performed on the respective logical qubits.

11. The system of claim 6, wherein the physical qubit connectivity information comprises:
a list of physical qubits; and
a list of edges that connect respective ones of the physical qubits.

12. The system of claim 6, wherein:
the quantum hardware device is a quantum hardware device of a quantum hardware provider;
the quantum hardware provider is accessible to the quantum compilation service via the service provider network; and
the physical qubit connectivity information comprises an indication of the quantum hardware provider.

13. The system of claim 6, wherein:
the request further comprises time-out information, wherein the time-out information comprises instructions to terminate the request provided to the SAT solver if a solution is not determined via the SAT solver within a given amount of time.

14. The system of claim 6, wherein to determine the mapping recommendation, the one or more computing devices are further configured to:
determine that the results comprise two or more satisfiable solutions; and
generate the quantum circuit mapping, wherein the quantum circuit mapping is generated based, at least in part, on a selected one of the two or more satisfiable solutions.

15. The system of claim 6, wherein the layout-transition-based order encoding scheme comprises:
one or more gate scheduling conditions, corresponding to implementations of respective gates of the logical quantum circuit information with respect to given SWAP gates of the number of SWAP gates, for the quantum circuit mapping, wherein the one or more gate scheduling conditions are represented by respective Boolean variables;
one or more qubit mapping conditions, corresponding to mappings of given logical qubits of the logical quantum circuit information to one or more physical qubits of the physical qubit connectivity information, respectively, for the quantum circuit mapping, wherein the one or more qubit mapping conditions are represented by additional respective Boolean variables; and
one or more SWAP selection operand conditions, corresponding to implementations of respective SWAP gates of the number of SWAP gates, for the quantum circuit mapping, wherein the one or more SWAP operand selection conditions are represented by other respective Boolean variables.

16. A method for mapping a logical quantum circuit for execution using a quantum hardware device, the method comprising:
generating a layout-transition-based order encoding scheme to be used in encoding a quantum circuit mapping;
receiving a request to generate a quantum circuit mapping for execution using the quantum hardware device, wherein the request comprises:
logical quantum circuit information corresponding to the logical quantum circuit;
physical qubit connectivity information corresponding to the quantum hardware device; and
a number of SWAP gates to be used in the quantum circuit mapping;
encoding the quantum circuit mapping as a SAT solver problem, wherein the encoding comprises generating a Conjunctive Normal Form (CNF) equation that represents the quantum circuit mapping based, at least in part, on:
the layout-transition-based order encoding scheme; and
the request;
providing the encoded SAT solver problem to a SAT solver;
receiving results of the SAT solver;
determining a mapping recommendation based, at least in part, on the results of the SAT solver; and
providing the mapping recommendation.

17. The method of claim 16, wherein:
said encoding the quantum circuit mapping further comprises:
generating a list of physical qubits based, at least in part, on the physical qubit connectivity information; and
generating a list of edges that connect respective ones of the physical qubits based, at least in part, on the physical qubit connectivity information; and
the generating the CNF equation is further based, at least in part, on the list of physical qubits and on the list of edges.

18. The method of claim 16, wherein:
said encoding the quantum circuit mapping further comprises:
generating a list of logical qubits based, at least in part, on the logical quantum circuit information; and
generating a list of gates to be performed on respective ones the logical qubits, wherein the list of gates is ordered in terms of one or more dependencies of outcomes of respective gates performed on respective logical qubits of the list of logical qubits on other respective gates performed on the respective logical qubits; and
the generating the CNF equation is further based, at least in part, on the list of logical qubits and on the list of gates.

19. The method of claim 16, wherein the generating the layout-transition-based order encoding scheme comprises:
determining one or more gate scheduling conditions, wherein:
the one or more gate scheduling conditions correspond to implementations of respective gates of the logical quantum circuit information with respect to given SWAP gates of the number of SWAP gates, for the quantum circuit mapping; and
the one or more gate scheduling conditions are represented by respective Boolean variables;
determining one or more qubit mapping conditions, wherein:
the one or more qubit mapping conditions correspond to mappings of given logical qubits of the logical quantum circuit information to one or more physical qubits of the physical qubit connectivity information, respectively, for the quantum circuit mapping; and
the one or more qubit mapping conditions are represented by additional respective Boolean variables; and
determining one or more SWAP operand selection conditions, wherein:
the one or more SWAP operand selection conditions correspond to implementations of respective SWAP gates of the number of SWAP gates, for the quantum circuit mapping; and
the one or more SWAP operand selection conditions are represented by other respective Boolean variables.

20. The method of claim 16, further comprising:
encoding one or more alternative quantum circuit mappings as one or more alternative SAT solver problems, wherein said encoding comprises generating one or more alternative CNF equations that represent the respective one or more alternative quantum circuit mappings based, at least in part, on:
the logical quantum circuit information;
the physical qubit connectivity information; and
one or more alternative quantities of SWAP gates indicated in the request or in one or more additional requests; and
providing the one or more encoded alternative SAT solver problems to the SAT solver in parallel with the encoded SAT solver problem.
